(19) United States
(12) Patent Application Publication
(10) Pub. No.: US 2025/0070568 A1
(43) Pub. Date: Feb. 27, 2025

(54) UNIT COMMITMENT METHOD FOR POWER SYSTEMS AND ASSOCIATED COMPONENTS

(71) Applicant: Tsinghua University, Beijing (CN)

(72) Inventors: Feng LIU, Beijing (CN); Kai KANG, Beijing (CN); Yifan SU, Beijing (CN); Ning QI, Beijing (CN)

(73) Assignee: Tsinghua University, Beijing (CN)

(21) Appl. No.: 18/590,669

(22) Filed: Feb. 28, 2024

(30) Foreign Application Priority Data
Jul. 31, 2023 (CN) 2023109547446

(51) Int. Cl. H02J 3/46; H02J 3/00; H02J 3/38

(52) U.S. Cl. CPC H02J 3/466; H02J 3/001; H02J 3/381; H02J 2203/10; H02J 2203/20; H02J 2300/20

(57) ABSTRACT

The present application provides a unit commitment method for a power system and associated components, the method includes: determining a unit commitment value of the thermal power unit and a unit commitment value of the renewable energy unit obtained based on a pre-scheduling stage optimization model by considering an N−1 fault and frequency security of the power system; verifying the unit commitment value of the thermal power unit and the unit commitment value of the renewable energy unit based on a re-scheduling stage optimization model; when the verification successes, taking the unit commitment value of the thermal power unit and the unit commitment value of the renewable energy unit as a final unit commitment value; when the verification fails, updating the pre-scheduling stage optimization model and repeating the determining step and the verifying steps, making decisions to the unit commitment of the power system to obtain a unit commitment plan ensuring frequency security and power supply-demand balance after N−1 fault occurred in the power system.

### TECHNICAL FIELD

The present application relates to the field of power system scheduling and operation, and in particular to a unit commitment method for a power system and associated components.

### BACKGROUND

Power systems are gradually evolving into “double high” power systems with high penetration of renewable energy plus high penetration of power electronics. However, such characteristics pose serious challenges to system frequency security: on the one hand, renewable energy connected to a power grid through power electronics devices does not have spontaneous frequency modulation capability, and against the backdrop of the increasing penetration of renewable energy and the gradual withdrawal of thermal power units from operation, the rotational inertia and frequency modulation capability of power systems are significantly reduced; on the other hand, in the “double high” power systems, the randomness and fluctuation of output power of renewable energy are aggravated, and the types of power system faults are more complex, which lead the power system to more frequent and severe instantaneous power imbalances and frequency dynamic deterioration. Therefore, it is a critical research direction to ensure the frequency security of the power system in the context of a significant decrease in system frequency modulation capability and aggravated active power disturbances.

A unit commitment model is one of the most important models for power system scheduling, which is calculated in the day-ahead stage to determine start-up or shut-down status of each unit during the intraday stage. Due to the fact that thermal power units are important frequency modulation resources in power systems, a day-ahead commitment result of units directly affects the intraday frequency modulation capability of power systems, thereby affecting the economic and safe operation of power systems.

### SUMMARY

The present application provides a unit commitment method for a power system and associated components. Based on a day-ahead unit commitment scheduling model of the power system, unit commitment of the power system is determined to obtain a unit commitment plan ensuring frequency security and power balance after an N−1 fault has occurred in the power system.

The present application provides a unit commitment method for a power system, applied to a power system, where the power system includes at least a thermal power unit and a renewable energy unit, and the method includes: determining a unit commitment value of the thermal power unit and a unit commitment value of the renewable energy unit obtained based on a pre-scheduling stage optimization model by considering an N−1 fault and frequency security of the power system; verifying the unit commitment value of the thermal power unit and the unit commitment value of the renewable energy unit based on a re-scheduling stage optimization model; when the verification of the unit commitment value of the thermal power unit and the unit commitment value of the renewable energy unit successes, taking the unit commitment value of the thermal power unit and the unit commitment value of the renewable energy unit as a final unit commitment value; and when the verification of the unit commitment value of the thermal power unit and the unit commitment value of the renewable energy unit fails, updating the pre-scheduling stage optimization model to repeat the determining step and the verifying step based on the updated pre-scheduling stage optimization model until the verification of the unit commitment value of the thermal power unit and the unit commitment value of the renewable energy unit obtained again successes, taking the verified unit commitment value of the thermal power unit and the verified unit commitment value of the renewable energy unit as the final unit commitment value, where the N−1 fault represents a contingency in which a component in the power system exits operation.

In an embodiment, the determining process for the unit commitment value of the thermal power unit and the unit commitment value of the renewable energy unit obtained based on the pre-scheduling stage optimization model by considering the N−1 fault and frequency security of the power system includes: determining a convex frequency indicator constraint of the power system from parameters of the power system based on a frequency response transfer function model and an outer approximation algorithm, where the convex frequency indicator constraint of the power system includes a maximum frequency change rate constraint, a maximum frequency deviation constraint, and a quasi-steady state frequency deviation constraint; initializing iteration parameters, a renewable energy severe scenario set, and an N−1 fault set; and based on the convex frequency indicator constraint of the power system, the iteration parameters, the renewable energy severe scenario set, and the N−1 fault set, obtaining a decision values of pre-scheduling variables, the unit commitment value of the thermal power unit, and the unit commitment value of the renewable energy unit obtained based on the pre-scheduling stage optimization model by considering the N−1 fault and frequency security of the power system.

In an embodiment, after determining the unit commitment value of the thermal power unit and the unit commitment value of the renewable energy unit obtained based on the pre-scheduling stage optimization model by considering the N−1 fault and frequency security of the power system, the method further includes: obtaining a decision value of an objective function of the pre-scheduling stage optimization model based on the decision value of the pre-scheduling variables, the unit commitment value of the thermal power unit, and the unit commitment value of the renewable energy unit; and updating a lower bound of the pre-scheduling stage optimization model based on the decision value of the objective function of the pre-scheduling stage optimization model using a first preset formula, where the first preset formula is:

LB^{CCG}=SOTₙ^{MP},

where LB^{CCG} is the lower bound of the pre-scheduling stage optimization model, CCG is a column-and-constraint generation algorithm, SOTₙ^{MP} is the decision value of the objective function of the pre-scheduling stage optimization model, n is the iteration parameters, and MP is the pre-scheduling stage.

In an embodiment, before verifying the unit commitment value of the thermal power unit and the unit commitment value of the renewable energy unit based on the re-scheduling stage optimization model, the method further includes: based on the convex frequency indicator constraint of the power system, the iteration parameters, the renewable energy severe scenario set, and the N−1 fault set, obtaining a decision value of an active power output of the renewable energy unit and a decision value of an operating state of an N−1 fault power equipment based on the re-scheduling stage optimization model; determining a decision value of an objective function of the re-scheduling stage optimization model based on the decision value of the active power output of the renewable energy units and the decision value of the operating state of the N−1 fault power equipment; and based on the decision value of the objective function of the re-scheduling stage optimization model, updating an upper bound of the re-scheduling stage optimization model based on a second preset formula, where the second preset formula is:

$$U {B}^{C C G} = {SOT}_{n}^{M P} - {H}_{n}^{M P} + {H}_{n}^{S P} ,$$

where UB^{CCG} is the upper bound of the re-scheduling stage optimization model, SOTₙ^{MP} is the decision value of the objective function of the pre-scheduling stage optimization model, Hₙ^{MP} is the decision value of the pre-scheduling variable, Hₙ^{MP} is the decision value of the objective function of the re-scheduling stage optimization model, CCG is the column-and-constraint generation algorithm, n is the iteration parameters, MP is the pre-scheduling stage, and SP is the re-scheduling stage.

In an embodiment, verifying the unit commitment value of the thermal power unit and the unit commitment value of the renewable energy unit based on the re-scheduling stage optimization model includes: when the lower bound of the pre-scheduling stage optimization model and the upper bound of the re-scheduling stage optimization model satisfy a third preset formula, indicating that verification of the unit commitment value of the thermal power unit and the unit commitment value of the renewable energy unit successes; and when the lower bound of the pre-scheduling stage optimization model and the upper bound of the re-scheduling stage optimization model do not satisfy the third preset formula, indicating that verification of the unit commitment value of the thermal power unit and the unit commitment value of the renewable energy unit fails, where the third preset formula is:

$$U {B}^{C C G} - L {B}^{C C G} \leq {δ}_{C C G} ,$$

where LB^{CCG} is the lower bound of the pre-scheduling stage optimization model, UB^{CCG} is the upper bound of the re-scheduling stage optimization model, and δ^{CCG} is a preset convergence threshold.

In an embodiment, when the verification of the unit commitment value of the thermal power unit and the unit commitment value of the renewable energy unit fails, updating the pre-scheduling stage optimization model includes: when the lower bound of the pre-scheduling stage optimization model and the upper bound of the re-scheduling stage optimization model do not satisfy the third preset formula, updating the iteration parameters, updating the renewable energy severe scenario set, and the N−1 fault set to update the pre-scheduling stage optimization model based on the updated iteration parameters, the updated renewable energy severe scenario set, and the updated N−1 fault set.

In an embodiment, determining the convex frequency indicator constraint of the power system from the parameters of the power system based on the frequency response transfer function model and an outer approximation algorithm includes: obtaining a non-convex nonlinear frequency indicator constraint of the power system from the parameters of the power system based on the frequency response transfer function model of the power system; and converting the non-convex nonlinear frequency indicator constraint of the power system into the convex frequency indicator constraint applicable to the pre-scheduling stage optimization model and the re-scheduling stage optimization model of the power system based on the outer approximation algorithm.

The present application further provides an electronic device including a memory, a processor, and a computer program stored on the memory and capable of running on the processor, where the processor executes the computer program to perform the unit commitment method for the power system as described above.

The present application further provides a non-transient computer-readable storage medium on which a computer program is stored. The computer program, when executed by a processor, performs the unit commitment method for the power system as described above.

The present application further provides a computer program product including a computer program. The computer program, when executed by a processor, performs the unit commitment method for the power system as described above.

The unit commitment method for the power system and associated components provided by the present application are applied to a power system including at least a thermal power unit and a renewable energy unit. The method includes: determining a unit commitment value of the thermal power unit and a unit commitment value of the renewable energy unit obtained based on a pre-scheduling stage optimization model by considering an N−1 fault and frequency security of the power system; verifying the unit commitment value of the thermal power unit and the unit commitment value of the renewable energy unit based on a re-scheduling stage optimization model; when the verification of the unit commitment value of the thermal power unit and the unit commitment value of the renewable energy unit successes, taking the unit commitment value of the thermal power unit and the unit commitment value of the renewable energy unit as a final unit commitment value; when the verification of the unit commitment value of the thermal power unit and the unit commitment value of the renewable energy unit fails, updating the pre-scheduling stage optimization model, and repeating the determining step and the verifying step based on the updated pre-scheduling stage optimization model until the verification of the unit commitment value of the thermal power unit and the unit commitment value of the renewable energy unit obtained again successes, taking the verified unit commitment value of the thermal power unit and the verified unit commitment value of the renewable energy unit as the final unit commitment value, where the N−1 fault represents a contingency in which a component in the power system exits operation. This method may make decisions on the unit commitment of the power system and obtain a unit commitment plan ensuring frequency security and power supply-demand balance after an N−1 fault occurs in the power system.

### BRIEF DESCRIPTION OF DRAWINGS

To illustrate the solutions of the embodiments based on the present application, the accompanying drawings used in the description of the embodiments are briefly introduced below. It should be noted that the drawings in the following description are only some embodiments of the present application. For those of ordinary skill in the art, other drawings can be obtained based on these drawings without creative effort.

FIG. 1 is a schematic flowchart of a unit commitment method for a power system according to the present application;

FIG. 2 is a specific flowchart of the unit commitment method for the power system according to the present application;

FIG. 3 is a schematic diagram of a principle of a frequency response transfer function model for a power system according to the present application; and

FIG. 4 is a schematic structural diagram of an electronic device according to the present application.

### DETAILED DESCRIPTION OF THE EMBODIMENTS

To illustrate the objects, solutions, and advantages of the present application, the solutions in present the application will be described clearly and completely below in combination with the drawings in the present application. The described embodiments are part of the embodiments of the present application, not all of them. All other embodiments obtained by a person of ordinary skill in the art based on the embodiments of the present application without any creative effort belong to the scope of the present application.

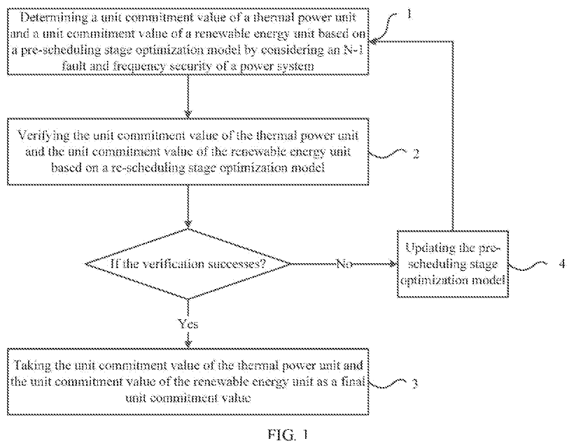

The following describes a unit commitment method for a power system and associated components of the present application, in conjunction with FIG. 1 to FIG. 4.

Referring to FIG. 1, which is a schematic flowchart of a unit commitment method for a power system according to the present application.

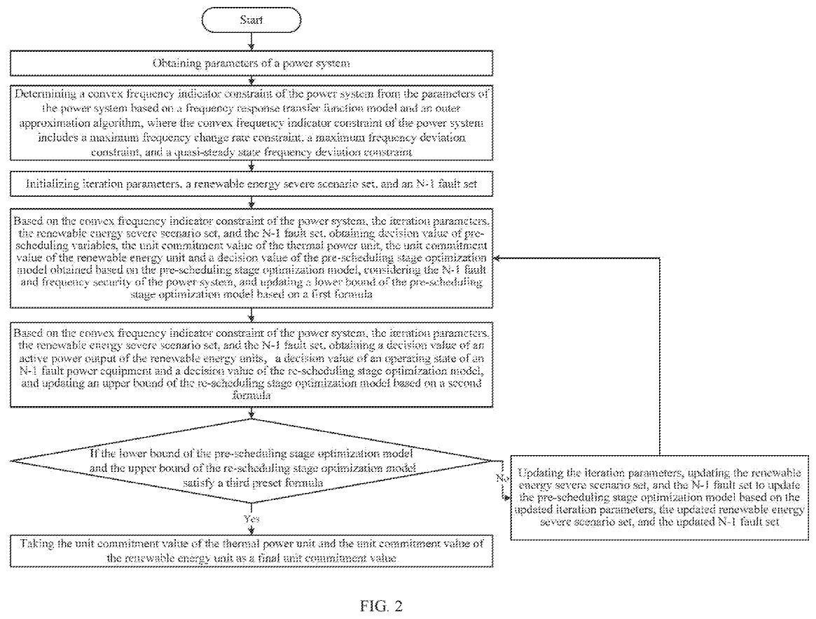

Referring to FIG. 2, which is a specific flowchart of the unit commitment method for the power system according to the present application.

The present application provides a unit commitment method for a power system, applied to a power system, which at least includes a thermal power unit and a renewable energy unit. The method includes following steps.

1, Determining a unit commitment value of the thermal power unit and a unit commitment value of the renewable energy unit obtained based on a pre-scheduling stage optimization model by considering an N−1 fault and frequency security of the power system, where the N−1 fault represents a contingency in which a component (such as a transmission line, a load, a generator, etc.) in the power system exits operation.

In an embodiment, the determining the unit commitment value of the thermal power unit and the unit commitment value of the renewable energy unit obtained based on the pre-scheduling stage optimization model, considering the N−1 fault and frequency security of the power system includes:
11, determining a convex frequency indicator constraint of the power system from the parameters of the power system based on a frequency response transfer function model and an outer approximation algorithm, where the convex frequency indicator constraint of the power system includes a maximum frequency change rate constraint, a maximum frequency deviation constraint, and a quasi-steady state frequency deviation constraint.

It should be noted that the unit commitment value of the renewable energy unit represents whether renewable energy provides frequency modulation capability. If renewable energy unit j provides frequency modulation capability during time period t, the corresponding unit commitment value of the renewable energy unit is 1; otherwise, the corresponding unit commitment value of the renewable energy unit is 0.

In an embodiment, determining the convex frequency indicator constraint of the power system from the parameters of the power system based on the frequency response transfer function model and the outer approximation algorithm includes: 101, obtaining a non-convex nonlinear frequency indicator constraint of the power system from the parameters of the power system based on the frequency response transfer function model of the power system.

First, the parameters of the power system are obtained.

Thermal power unit parameters. An index of the thermal power unit is denoted as i, and the parameters of the thermal power unit include a power output range [Pᵢ^{G}, Pᵢ^{-G}] of unit i, a ramp up speed Rᵢ⁺, a ramp down speed Rᵢ⁻, a minimum operating time Tᵢ^{ON}a minimum off time Tᵢ^{OFF}, a start-up cost Cᵢ^{SU}, a shut-down cost Cᵢ^{SD}, a power generation cost per unit Cᵢ^{G}, and a generation shift factor SF_{l,i}^{G} of the thermal power unit i with respect to the transmission line l. The set and number of the thermal power unit are denoted as N_{G} and N_{G}, respectively.

Load parameters. An index of the load is denoted as d, and the load parameters include a forecast value P_{d,t}^{D} of the load d during the time period t and a generation shift factor SF_{l,d}^{D} of the load d with respect to the transmission line 1. The set and number of the load are denoted as N_{D} and N_{D}, respectively.

Renewable energy station parameters. An index of the renewable energy station is denoted as j, and the renewable energy station parameters include an installed capacity Pⱼ^{RStation} of the station j, a center value of forecast power outputs P_{j,t}^{R} of the station j during the time period t, a forecast power output range [P_{j,r}^{R}, P_{j,t}^{-R}], and a generation shift factor SF_{l,j}^{R} of the station j with respect to the transmission line 1. The set and number of the renewable energy station are denoted as N_{R} and N_{R}, respectively. A load shedding power required to be offered by a frequency support capability with an inertia coefficient Hⱼ^{R} of the station j is denoted as Pⱼ^{Rshed}.

Energy storage station parameters. An index of the energy storage station is denoted as k, and parameters of the energy storage station include an upper limit of charging and discharging power P̅ₖ^{ESS}, a capacity range [Eₖ^{ESS}, Ēₖ^{ESS}] charging and discharging efficiency ηₖ^{CH} and ηₖ^{DC}, initial capacity Eₖ^{INT}, a charging and discharging power cost per unit Cₖ^{ESS}, and a generation shift factor SF_{l,k}^{ESS} of the energy storage station k with respect to the transmission line l. The set and number of energy storage are denoted as SS and [symbol] _{ESS} and N_{ESS}, respectively.

An index of a transmission line is denoted as l, a maximum power transmission capacity of the transmission line l is P̅ₗ^{L}, and the set and number of the transmission line are denoted as L and N_{L}, respectively; the set and number of node are denoted as B and N_{B}, and the set and number of scheduling time period are denoted as T and N_{T}. A unit call cost of power balance emergency regulation resource and transmission line congestion emergency regulation resource are denoted as C^{S} and C^{SL}, respectively, and an emergency regulation cost of frequency dynamic constraint is denoted as C^{SF}.

The frequency dynamics of the power system may be formulated by a first-order swing equation, as shown in equation (1):

$$2 {H}^{G} \frac{dΔf ( t )}{dt} + {D}^{L} Δ f ( t ) = - Δ {P}_{e} ( t ) + Δ {P}_{m} ( t ) , \qquad ( 1 )$$

where H^{G} and D^{L} are a power unit inertia time constant and a load equivalent damping coefficient, respectively, Δf(t), ΔPₑ (t) and ΔPₘ(t) are a system frequency deviation, a system power imbalance, and a system active power support, respectively.

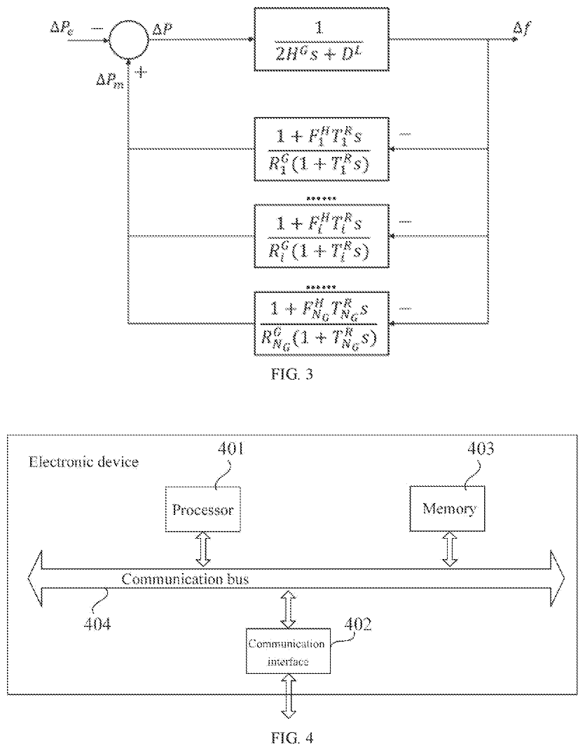

Referring to FIG. 3, which is a schematic diagram of a principle of a frequency response transfer function model for a power system according to the present application.

A frequency response transfer function model of the power system is constructed by considering a dynamic frequency support, a load damping support, and a renewable energy virtual inertia support of the thermal power unit. The sets of the thermal power unit, the renewable energy unit, and the load are denoted as [symbol] _{G}, N_{R} and N_{D}, respectively, and the number of elements in these sets are denoted as N_{G}, N_{R} and N_{D}, respectively. Therefore, the frequency response transfer function model of the power system is shown in FIG. 3, where ΔPₑ is the system power imbalance, ΔPₘ is the system active power support, ΔP is a difference between ΔPₘ and ΔPₑ, and Rᵢ^{G}, Fᵢ^{H} and Tᵢ^{R} are a droop coefficient, reheat proportional coefficient, and reheat time constant of the thermal power unit i (i ∈ N_{G}), respectively.

The power unit inertia time constant H^{G} and the load equivalent damping coefficient D^{L} may be calculated based on the physical meaning of the parameters: a reference value of a system frequency modulation coefficient is P_{BASE}, the inertia time constant and installed capacity of the thermal power unit i (i ∈N_{G}) are denoted as Hᵢ^{G} and P̅ᵢ^{G}, respectively, the damping coefficient and the load value of the load d are denoted as D_{d}^{L} and P_{d}^{D}, respectively, and the inertia time constant and installed capacity of the renewable energy unit j (j ∈ N_{R}) are denoted as Hⱼ^{R} and P̅ⱼ^{R}, respectively. H^{G} and D^{L} may be formulated by equations (2) and (3):

$${H}^{G} = \frac{{\sum }_{i = 1}^{{N}_{G}} {H}_{i}^{G} \cdot {\overline{P}}_{i}^{G} + {\sum }_{j = 1}^{{N}_{R}} {H}_{j}^{R} \cdot {\overline{P}}_{j}^{RStation}}{{P}_{BASE}} , \qquad ( 2 )$$

$${D}^{L} = \frac{{\sum }_{d = 1}^{{N}_{D}} {D}_{d}^{L} \cdot {P}_{d}^{D}}{{P}_{BASE}} . \qquad ( 3 )$$

It should be noted that due to the different parameters of the thermal power unit, it is difficult to directly derive the frequency dynamic equation using the transfer function model in FIG. 3. Previous studies have shown that an aggregated droop coefficient R^{G}, an aggregated reheat proportional coefficient F^{H}, and an aggregated reheat time constant T^{R} of the thermal power unit may be calculated through parameter aggregation.

A frequency modulation power per unit μᵢ and a normalized frequency modulation power per unit λᵢ of the thermal power unit i are defined, and their expressions are shown in detail in equations (4) and (5), where ƒ₀ is a rated frequency of the system. Thus, the aggregated droop coefficient R^{G}, the aggregated reheat proportional coefficient F^{H}, and the aggregated reheat time constant T^{R} of the power system are shown in equations (6)-(8), respectively.

$${μ}_{i} = {( {R}_{i}^{G} )}^{- 1} \cdot \frac{{\overline{P}}_{i}^{G}}{{f}_{0}} \qquad ( 4 )$$

$${λ}_{i} = \frac{{μ}_{i}}{{\sum }_{i = 1}^{{N}_{G}} {μ}_{i}} \qquad ( 5 )$$

$${R}^{G} = \frac{{P}_{BASE}}{{\sum }_{i = 1}^{{N}_{G}} {( {R}_{i}^{G} )}^{- 1} \cdot {\overline{P}}_{i}^{G}} \qquad ( 6 )$$

$${F}^{H} = {\sum }_{i = 1}^{{N}_{G}} {λ}_{i} \cdot {F}_{i}^{H} \qquad ( 7 )$$

$${T}^{R} = {\sum }_{i = 1}^{{N}_{G}} {λ}_{i} \cdot {T}_{i}^{R} \qquad ( 8 )$$

Using the frequency response transfer function shown in FIG. 3 and in combination with the aggregated parameters of the power system, a functional relationship between a frequency change Δƒ(s) and an instantaneous active power deviation ΔPₑ of the power system is shown in equation (9), where the expressions for ωₙ and ζ are detailed in equations (10) and (11).

$$Δ f ( s ) = - \frac{Δ {P}_{e}}{{D}^{L} + {( {R}^{G} )}^{- 1}} \cdot [ \frac{1}{s} - \frac{s + 2 ζ {ω}_{n} - {{T}^{R} ( {ω}_{n} )}^{2}}{{s}^{2} + 2 ζ {ω}_{n} s + {( {ω}_{n} )}^{2}} ] \qquad ( 9 )$$

$${ω}_{n} = \sqrt{\frac{{D}^{L} + {( {R}^{G} )}^{- 1}}{2 {H}^{G} {T}^{R}}} \qquad ( 10 )$$

$$ζ = \frac{2 {H}^{G} + {D}^{L} {T}^{R} + {( {R}^{G} )}^{- 1} {F}^{H} {T}^{R}}{2 \sqrt{2 {H}^{G} {T}^{R} [ {D}^{L} + {( {R}^{G} )}^{- 1} ]}} \qquad ( 11 )$$

Further, the expression shown in equation (9) is converted into a time-domain expression, as shown in equation (12), where the expressions for ω_{d}² and ϕ are shown in detail in equations (13) and (14).

$$Δ f ( t ) = - \frac{Δ {P}_{e}}{{D}^{L} + {( {R}^{G} )}^{- 1}} \cdot ( 1 + \sqrt{\frac{{( {T}^{R} {ω}_{n} )}^{2} - 2 ζ {ω}_{n} {T}^{R} + 1}{1 - {ζ}^{2}}} {e}^{- ζ {ω}_{n} t} sin ( {ω}_{d} t + ϕ ) ) \qquad ( 12 )$$

$${ω}_{d}^{2} = {ω}_{n}^{2} ( 1 - {ζ}^{2} ) \qquad ( 13 )$$

$$ϕ = arctan ( - \frac{\sqrt{1 - {ζ}^{2}}}{{T}^{R} {ω}_{n} - ζ} ) \qquad ( 14 )$$

Frequency dynamic indicators of the power system mainly include a maximum frequency change rate RoCoFₘₐₓ, a maximum frequency deviation Δfₘₐₓ, and a quasi-steady state frequency deviation Δƒ_{qss}, and correspondingly a maximum frequency change rate constraint, a maximum frequency deviation constraint, and a quasi-steady state frequency deviation constraint, which are non-convex nonlinear frequency indicator constraints of the power system.

The maximum frequency change rate generally occurs at a moment when instantaneous active power deviation ΔPₑ occurs. At this time, Δƒ(t)=0, and a frequency change rate threshold of the power system is denoted as RoCoF_{threshold}, then the maximum frequency change rate constraint is shown in equation (15):

$$\vert \frac{Δ {P}_{e}}{2 {H}^{G}} \vert \leq {RoCoF}_{threshold} . \qquad ( 15 )$$

The maximum frequency deviation Δfₘₐₓ occurs at a moment when dΔƒ(t)/dt=0, and the moment is denoted as t_{nadir}, which expression is shown in equation (16):

$${t}_{nadir} = \frac{arctan [ {T}^{R} {ω}_{d} / ( {T}^{R} ζ {ω}_{n} - 1 ) ]}{{ω}_{d}} . \qquad ( 16 )$$

t_{nadir} is substituted into equation (12) to obtain the expression for the maximum frequency deviation Δƒₘₐₓ, which is shown in equation (17):

$$Δ f {\frac{Δ {P}_{e}}{{D}^{L} + {( {R}^{G} )}^{- 1}} [ 1 + \sqrt{{( {T}^{R} {ω}_{n} )}^{2} - 2 ζ {ω}_{n} {T}^{R} + 1} \cdot {e}^{- {ζω}_{n} {t}_{nadir}} ]}_{m ax} . \qquad ( 17 )$$

The maximum frequency deviation Δƒₘₐₓ of the power system cannot exceed a system security threshold ΔF_{threshold}, then the maximum frequency deviation constraint as shown in equation (18) is derived.

$$\vert - \frac{Δ {P}_{e}}{{D}^{L} + {( {R}^{G} )}^{- 1}} \cdot [ 1 + \sqrt{{( {T}^{R} {ω}_{n} )}^{2} - 2 ζ {ω}_{n} {T}^{R} + 1} \cdot {e}^{- ζ {ω}_{n} {t}_{nadir}} ] \vert \leq Δ {F}_{threshord} \qquad ( 18 )$$

The maximum frequency deviation constraint shown in constraint (18) is a typical non-convex constraint, which will bring significant difficulties to the training of a frequency constrained unit commitment model.

102, Converting the non-convex nonlinear frequency indicator constraints of the power system into the convex frequency indicator constraints applicable to the pre-scheduling stage optimization model and the re-scheduling stage optimization model of the power system based on an outer approximation algorithm.

Different from most approaches of introducing integer variables for a piecewise linearization method, in the present application, an outer approximation method is used to obtain an approximate linearization of the equation (18). The outer approximation method includes determining a certain number of hyperplanes through the idea of convex relaxation, and fitting a given function or constraint in the form of a convex hull. Although this method cannot theoretically guarantee the equivalent conversion of the non-convex constraints, in an actual power system, parameters H^{G}, R^{G}, T^{R} and F^{H} have typical value ranges. Constructing appropriate hyperplanes and reserving reasonable margins may fit the maximum frequency deviation constraint within a small error range, and then the actual needs of a project are met. Moreover, the hyperplane obtained by outer approximation method may avoid introducing integer variables and significantly reduce training complexity of the model. By converting the parameters related to the unit commitment decision variables in equation (18) to one side of the inequality and the constants in equation (18) to the other side of the inequality, the maximum frequency deviation constraint shown in equation (19) may be obtained:

$$\frac{{D}^{L} + {( {R}^{G} )}^{- 1}}{[ 1 + \sqrt{{( {T}^{R} {ω}_{n} )}^{2} - 2 ζ {ω}_{n} {T}^{R} + 1} \cdot {e}^{- {ζω}_{n} {t}_{nadir}} ]} \geq \frac{Δ {P}_{e}}{Δ {F}_{threshord}} . \qquad ( 19 )$$

When parameters are aggregated using equations (6)-(8), it may be set that Δ^{TR}=T^{R}(R^{G})⁻¹, α^{HG}=H^{G}, αR^{G}=(R^{G})⁻¹ and α^{FH}=F^{H}(R^{G})⁻¹. (α^{HG},α^{RG},α^{TR},α^{FH}) may be used as coordinate parameters for linearization. The coordinate parameters in this form may be expressed linearly by the unit commitment variables, and the function on the left side of the inequality in equation (19) is denoted as g(α^{HG},α^{RG},α^{TR},α^{FH}).

The range of values for each of the four elements in (α^{HG},α^{RG},α^{TR},α^{FH}) are denoted as Ω_{HG}, Ω_{RG}, Ω_{TR}, Ω_{FH}, respectively. The method for converting the maximum frequency deviation constraints based on outer approximation is described below.

A feasible point h is denoted as (αₕ^{HG}, αₕ^{RG}, αₕ^{TR}, αₕ^{FH}) then the linearization function of the function g(α^{HG}, α^{RG}, α^{TR}, α^{GH}) at the feasible point h is shown in equation (20), where α and α^{h} are abbreviations of (α^{HG},α^{RG},α^{TR},α^{FH}) and (αₕ^{HG}, αₕ^{RG}, αₕ^{TR}, αₕ^{FH}), respectively:

$${L}_{h} ( {α}_{h}^{HG} , {α}_{h}^{RG} , {α}_{h}^{TR} , {α}_{h}^{FH} ) = g ( {α}_{h}^{HG} , {α}_{h}^{RG} , {α}_{h}^{TR} , {α}_{h}^{FH} ) + \frac{\partial g}{\partial {α}^{HG}} {\vert}_{α = {α}_{h}} ( {α}^{HG} - {α}_{h}^{HG} ) + \frac{\partial g}{\partial {α}^{RG}} {\vert}_{α = {α}_{h}} ( {α}^{RG} - {α}_{h}^{RG} ) + \frac{\partial g}{\partial {α}^{TR}} {\vert}_{α = {α}_{h}} ( {α}^{TR} - {α}_{h}^{TR} ) + \frac{\partial g}{\partial {α}^{FH}} {\vert}_{α = {α}_{h}} ( {α}^{FH} - {α}_{h}^{FH} ) . \qquad ( 20 )$$

The outer approximation algorithm includes the following steps.

Initializing. The number of hyperplanes N_{HP} is initialized to 1, the value of feasible point 1 is initialized as (αₕ^{HG}, αₕ^{RG}, αₕ^{TR}, αₕ^{FH}), the lower bound LB^{OA} of the initialization function g(α^{HG} α^{RG} α^{TR} α^{FH}) is initialized as −M^{big}, the upper bound UB^{OA} of the initialization function g(α^{HG},α^{RG},α^{TR},α^{FH}) is initialized as M^{big}, and an allowable error range between the upper and lower bounds is set to be δ_{OA}, where M^{big} is the number with a larger value.

2) Updating the lower bound LB^{OA} according to equation (21).

$${LB}^{O A} = max [ g ( {α}_{1}^{HG} , {α}_{1}^{RG} , {α}_{1}^{TR} , {α}_{1}^{FH} ) , … , g ( {α}_{h}^{HG} , {α}_{h}^{R G} , {α}_{h}^{TR} , {α}_{h}^{FH} ) , … , g ( {α}_{{N}_{HP}}^{HG} , {α}_{{N}_{HP}}^{RG} , {α}_{{N}_{HP}}^{TR} , {α}_{{N}_{HP}}^{FH} ) ] \qquad ( 21 )$$

3) Training the linear planning model shown in equation (22). This optimization model is based on the idea of outer approximation and provides an approximate upper bound for non-convex function (α_{N}_{_{HP}}₊₁^{HG}, α_{N}_{_{HP}}₊₁^{RG}, α_{N}_{_{HP}}₊₁^{TR}, α_{N}_{_{HP}}₊₁^{FH}). The optimal value of equation (22) is assigned to UB^{OA}, and an optimal solution of equation (22) is denoted as g(α^{HG},α^{RG},α^{TR},α^{FH}).

$${max}_{\begin{matrix}{α}^{HG} ∈ {Ω}_{HG} , {α}^{RG} ∈ {Ω}_{RG} , \\ {α}^{TR} ∈ {Ω}_{TR} , {α}^{FH} ∈ {Ω}_{FH}\end{matrix}} β \qquad ( 22 )$$

$$s . t .$$

$$β \leq {L}_{h} ( {α}_{h}^{HG} , {α}_{h}^{RG} , {α}_{h}^{TR} , {α}_{h}^{FH} ) ,$$

$$h = 1 , … , {N}_{HP} .$$

4) Determining convergence. If UB^{OA}−LB^{OA} is less than the threshold δ_{OA}, the calculation is terminated and Lₕ(αₕ^{HG},αₕ^{RG},αₕ^{TR},αₕ^{FH}), ∀h=1, . . . , N_{HP} is output according to equation (20), and these linear functions are the outer approximation results of the function g(α^{HG},α^{RG},α^{TR},α^{FH}); otherwise, N_{HP} is set to be N_{HP}+1 and the calculation proceeds to step 2) and the lower bound is updated according to equation (21).

The set composed of hyperplanes for fitting functions g(α^{HG},α^{RG},α^{TR},α^{FH}) is denoted as [symbol] _{HP}. Considering the potential errors caused by outer approximation algorithm, a deviation correction value δ_{REG} (δ_{REG}≥0) may be preset to correct the errors caused by outer approximation.

The approximate maximum frequency deviation constraint expressed through the hyperplane is shown in equation (23):

$${L}_{h} ( {α}_{h}^{HG} , {α}_{h}^{RG} , {α}_{h}^{TR} , {α}_{h}^{FH} ) - {δ}_{REG} \geq \frac{Δ {P}_{e}}{Δ {F}_{threshord}} , \qquad ( 23 )$$

$$h = 1 , … , {N}_{HP} .$$

When dΔƒ(t)/dt=0, it is necessary to consider the quasi-steady state frequency deviation constraint of the system. The quasi-steady state deviation safety threshold of the power system is denoted as FQSS_{threshold}, then from equation (1), the quasi-steady state deviation constraint may be expressed by equation (24):

$$\vert \frac{Δ {P}_{e}}{{D}^{L} + {( {R}^{G} )}^{- 1}} \vert \leq F Q S {S}_{threshold} . \qquad ( 24 )$$

Thus, the maximum frequency change rate constraint, the maximum frequency deviation constraint, and the quasi-steady state frequency deviation constraint have been derived, which are the convex frequency indicator constraints of the power system.

12, Initializing iteration parameters, the renewable energy severe scenario set, and the N−1 fault set.

Robust unit commitment is an important research direction in the field of robust scheduling, which is divided into a day-ahead pre-scheduling stage and an intraday re-scheduling stage. The pre-scheduling stage is used to decide the unit commitment value, and the actual power output value of the renewable energy unit and actual fault occurrence of a power grid in the power system are yet unknown during this stage; in the re-scheduling stage, the actual power output value of the renewable energy unit and the actual fault of a power grid have been observed. Then, the power system makes decisions on intraday operating variables to ensure the real-time and secure operation of the power system. The objective function of robust unit commitment is a minimized scheduling cost in the severest scenario. The pre-scheduling variable and re-scheduling variable of the power system may be denoted as vectors x and y, respectively, and the uncertain scenarios of the power system may be denoted as variable ζ. The uncertain scenarios ζ vary within the uncertainty set Ξ, and ζ ∈ Ξ, then a general model of robust unit commitment may be expressed by equation (25):

$${min}_{x} {c}^{T} x + {max}_{ξ ∈ Ξ} {min}_{y ∈ Ω ( x , ξ )} {b}^{T} y \qquad ( 25 )$$

$$s . t . Ax \geq d ,$$

$$Ω ( x , ξ ) = \{ y : Gy \geq h - Hx - F ξ \} .$$

In the N−1 secure and robust unit commitment model considering frequency constraints, the instantaneous active power deviation ΔPₑ of the constraint (23) is caused by N−1 fault and therefore ΔPₑ belongs to the element of the variable ζ. Both unit commitment decision and unit output decision in the variable x will affect the uncertainty range of ΔPₑ. Therefore, the uncertainty set Ξ will be affected by the pre-scheduling variable x, which reflects that this model is decision dependent (DD). The uncertainty set and uncertainty variables affected by decision variables are denoted as (x) and y respectively, and the expression of N−1 secure and robust unit commitment considering frequency constraints is shown in equation (26):

$${min}_{x} {c}^{T} x + {max}_{ξ ( x ) ∈ Ξ ( x )} {min}_{y ∈ Ω ( x , ξ ( x ) )} {b}^{T} y \qquad ( 26 )$$

$$s . t . Ax \geq d ,$$

$$Ω ( x , ξ ( x ) ) = \{ y : Gy \geq h - Hx - F ξ ( x ) \} .$$

Since the unit commitment has the characteristics of day-ahead and intraday stages, in the present application, the idea of an alternative iteration algorithm at the day-ahead pre-scheduling stage and the intraday re-scheduling stage is still used for performing iterative training on the model. Denoting an index of the number of iterations for pre-scheduling and rescheduling as n.

In the n-th iteration, the renewable energy severe scenario set considered in the pre-scheduling stage is denoted as Ωₙ^{R}, and the scenario e in the set is denoted as P_{j,t,e}^{RN}∀j, ∀t. The N−1 fault set considered in the pre-scheduling stage is denoted as yΩ_{Λ,n}^{NCut1}, where Λ may be taken as G, R, ESS, D, representing the N−1 fault sets of the thermal power unit, the renewable energy station, the energy storage station, and the loads.

The uncertainty set of the present application consists of a union of the renewable energy output uncertainty set Ωₙ^{R} and the N−1 fault set Ω_{Λ,n}^{NCut1} (∀Λ). In the number n of iterations, the set Ωₙ^{R} in the pre-scheduling stage has an equal number of scenarios as the set Ω_{Λ,n}^{Cut1} (∀Λ). At the n-th iteration, the number of scenarios in these sets is denoted as Nₙ^{Iter}. In the set Ω_{Λ,n}^{NCut1} (∀Λ), the elements of the scenario e are denoted as A_{q,t,e}^{Λ}(∀Λ, ∀q, ∀t), where q may be taken as the index i of the thermal power unit, the index j of the renewable energy unit, the index k of the energy storage station, or the index d of the load, and correspond to the type of Λ. A_{q,t,e}^{Λ} (∀Λ, ∀q, ∀t,∀e) has a value of 0 or 1, a value of 1 indicates that the power equipment q operates normally in the time period t and scenario e, and a value of 0 indicates a power equipment q is fault.

13, Based on the convex frequency indicator constraint of the power system, the iteration parameters, the renewable energy severe scenario set, and the N−1 fault set, obtaining decision value of pre-scheduling variables, the unit commitment value of the thermal power unit, and the unit commitment value of the renewable energy unit after N−1 fault of the power system based on the pre-scheduling stage optimization model.

In an embodiment, after determining the unit commitment value of the thermal power unit and the unit commitment value of the renewable energy unit after N−1 fault of the power system obtained based on the pre-scheduling stage optimization model, the method further includes: obtaining a decision value of an objective function of the pre-scheduling stage optimization model based on the decision value of the pre-scheduling variables, the unit commitment value of the thermal power unit, and the unit commitment value of the renewable energy unit; updating a lower bound of the pre-scheduling stage optimization model based on the decision value of the objective function of the pre-scheduling stage optimization model using a first preset formula; the first preset formula is:

LB^{CCG}=PSOTₙ^{MP},

where LB^{CCG} is the lower bound of the pre-scheduling stage optimization model, CCG is the column-and-constraint generation algorithm, SOTₙ^{MP} is the decision value of the objective function of the pre-scheduling stage optimization model, n is the iteration parameter, and MP is the pre-scheduling stage.

In and embodiment, equations (27)-(29) are the constraints of variables having a value of 0 or 1 that the unit commitment needs to satisfy. uᵢ^{G}(t)uᵢ^{SU}(t), uᵢ^{SD}(t) are a status variable, a start-up indicator variable, and a shut-down indicator variable of the thermal power unit, all of which are variables having a value of 0 or 1. Xᵢ^{ON} (t) and Xᵢ^{OFF}(t) are integer variables: Xᵢ^{ON}(t) is a unit operation duration variable, representing a continuous operation duration of the thermal power unit i during a time period t; and Xᵢ^{OFF} (t) is a unit shut-down duration variable, representing a duration of continuous shut-down of the thermal power unit i during the time period t.

$${u}_{i}^{SU} ( t + 1 ) - {u}_{i}^{SD} ( t + 1 ) = {u}_{i}^{G} ( t + 1 ) - {u}_{i}^{G} ( t ) , ∀ i , t \qquad ( 27 )$$

$$[ {X}_{i}^{ON} ( t ) - {T}_{i}^{ON} ] [ {u}_{i}^{G} ( t ) - {u}_{i}^{G} ( t + 1 ) ] \geq 0 , ∀ i , t \qquad ( 28 )$$

$$[ {X}_{i}^{OFF} ( t ) - {T}_{i}^{OFF} ] [ {u}_{i}^{G} ( t + 1 ) - {u}_{i}^{G} ( t ) ] \geq 0 , ∀ i , t \qquad ( 29 )$$

For the convenience of expression, defining an index b that characterizes an operating state of the power system: b=1 indicates normal operation of the power system, and b=2 indicates N−1 fault has occurred in the power system.

The pre-scheduling stage optimization model needs to ensure that all renewable energy scenarios in the set Ωₙ^{R} are feasible for scheduling b=1, and for the b=2 situations caused by all N−1 scenarios in the set Ω_{Λ,n}^{NCut1} (∀Λ), it is necessary to ensure the frequency security of the system and the safe operation of the power grid after faults.

A coefficient B_{q,t,e,b}^{Λ} is defined to characterize the operating state of the power equipment, B_{q,t,e,1}^{Λ}=1 if b=1, and B_{q,i,e,b}^{Λ}=A_{q,t,e}^{Λ}(∀q,∀t,∀e) if b=2. Under the above definition, B_{q,t,e,1}^{Λ} characterizes that when the renewable energy scenario is e, all power equipment operates normally; and B_{q,t,e,2}^{Λ} characterizes when the renewable energy scenario is e, the operating state of power equipment q under N−1 fault during the time period t and index e. If the power equipment q operates normally, then B_{q,t,e,2}^{Λ}=1, and if the power equipment q malfunctions, then B_{q,t,e,2}^{Λ}=0.

The thermal power unit needs to satisfy the upper and lower limits of unit output as well as ramp constraints, as shown in equations (30)-(32). Variable P_{i,e,b}^{G}(t) represents the active power output of the thermal power unit i during the normal operation of the system (b=1) or the occurrence of an N−1 fault (b=2) with index e in renewable energy scenario e and time period t.

$${u}_{i}^{G} ( t ) {B}_{i , t , e , b}^{G} {\underline{P}}_{i}^{G} \leq {p}_{i , e , b}^{G} ( t ) \leq {u}_{i}^{G} ( t ) {B}_{i , t , e , b}^{G} {\overline{P}}_{i}^{G} , ∀ i , t , e , b \qquad ( 30 )$$

$${p}_{i , e , b}^{G} ( t + 1 ) - {p}_{i , e , b}^{G} ( t ) \leq {u}_{i}^{G} ( t ) {R}_{i}^{+} + [ 1 - {u}_{i}^{G} ( t ) ] {\overline{P}}_{i}^{G} , ∀ i , t , e , b \qquad ( 31 )$$

$${p}_{i , e , b}^{G} ( t ) - {p}_{i , e , b}^{G} ( t + 1 ) \leq {u}_{i}^{G} ( t + 1 ) {R}_{i}^{-} + [ 2 - {u}_{i}^{G} ( t + 1 ) - {B}_{i , t + 1 , e , b}^{G} ] {\overline{P}}_{i}^{G} , ∀ i , t , e , b \qquad ( 32 )$$

The active power of the renewable energy station needs to satisfy constraints (33) and (34). Variable p_{j,e,b}^{R}(t) represents the active power output of the renewable energy station j during the normal operation of the system (b=1) or the occurrence of an N−1 fault (b=2) with index e in the renewable energy scenario e and time period t. Variable uⱼ^{R}(t) is a frequency support decision variable of the renewable energy station: if the station j participates in frequency support in the time period t, then uⱼ^{R}(t) is 1, and the station j needs to shed the power value of pⱼ^{RShed}; or uⱼ^{R}(t) is 0. Constraint (33) is the active power range constraint for the renewable energy station; and constraint (34) indicates that the lower limit of uncertain output of the renewable energy station providing frequency modulation support must not be less than the power shedding value pⱼ^{RShed}.

$$0 \leq {p}_{j , e , b}^{R} ( t ) \leq {B}_{j , t , e , b}^{R} [ {P}_{j , t , e}^{RN} - {u}_{j}^{R} ( t ) {P}_{j}^{RShed} ] , ∀ j , t , e , b \qquad ( 33 )$$

$${\underline{P}}_{j , t}^{R} - {u}_{j}^{R} ( t ) {P}_{j}^{RShed} \geq 0 , ∀ j , t \qquad ( 34 )$$

Constraints (35)-(40) are energy storage operation constraints. Variables p_{k,e,b}^{CH}(t), p_{k,e,b}^{DC}(t) and E_{k,e,b}^{ESS}(t) respectively represent a charging power, a discharging power, and a stored energy of the energy storage station k during the normal operation of the system (b=1) or the occurrence of an N−1 fault (b=2) with index e in the renewable energy scenario e and time period t. u_{k,e,b}^{ESS}(t) is a 0-1 variable, indicating that energy storage station k cannot charge and discharge simultaneously under corresponding conditions.

$$0 \leq {p}_{k , e , b}^{CH} ( t ) \leq {B}_{k , t , e , b}^{ESS} [ 1 - {u}_{k , e , b}^{ESS} ( t ) ] {\overline{P}}_{k}^{ESS} , ∀ k , t , e , b \qquad ( 35 )$$

$$0 \leq {p}_{k , e , b}^{DC} ( t ) \leq {B}_{k , t , e , b}^{ESS} {u}_{k , e , b}^{ESS} ( t ) {\overline{P}}_{k}^{ESS} , ∀ k , t , e , b \qquad ( 36 )$$

$${E}_{k , e , b}^{ESS} ( t ) = {E}_{k , e , b}^{ESS} ( t - 1 ) + {η}_{k}^{CH} {p}_{k , e , b}^{CH} ( t ) - \frac{{p}_{k , e , b}^{DC} ( t )}{{η}_{k}^{DC}} , ∀ k , t , e , b \qquad ( 37 )$$

$${\underline{E}}_{k}^{ESS} \leq {E}_{k , e , b}^{ESS} ( t ) \leq {\overline{E}}_{k}^{ESS} , ∀ k , t , e , b \qquad ( 38 )$$

$${E}_{k , e , b}^{ESS} ( 0 ) = {E}_{k}^{INT} , ∀ k , e , b \qquad ( 39 )$$

$${B}_{k , {N}_{T} , e , b}^{ESS} {E}_{k , e , b}^{ESS} ( {N}_{T} ) = {B}_{k , {N}_{T} , e , b}^{ESS} {E}_{k}^{INT} , ∀ k , e , b \qquad ( 40 )$$

Constraints (41)-(43) are system power balance constraint, transmission line capacity constraint, and power emergency regulation non-negative constraint, respectively. Variables p_{e,b}^{S+}(t), p_{e,b}^{S-}(t) represent the emergency power regulation value required to maintain system power balance in renewable energy scenario e and time period t, when the system operates normally (b=1) or when an N−1 fault (b=2) with index e occurs; and the variables p_{i,e,b}^{SL+}(t), p_{i,e,b}^{SL-}(t) are the power emergency regulation value that avoids transmission line l capacity congestion under corresponding conditions.

$${\sum }_{i ∈ {𝒩}_{G}} {p}_{i , e , b}^{G} ( t ) + {\sum }_{j ∈ {𝒩}_{R}} {p}_{j , e , b}^{R} ( t ) + {\sum }_{k ∈ {𝒩}_{E}} {p}_{k , e , b}^{CH} ( t ) - {\sum }_{k ∈ {𝒩}_{ESS}} {p}_{k , e , b}^{DC} ( t ) + {p}_{e , b}^{S +} ( t ) - {p}_{e , b}^{S -} ( t ) = {\sum }_{d ∈ {N}_{D}} {B}_{d , t , e , b}^{D} {P}_{d , t}^{D} , ∀ t , e , b \qquad ( 41 )$$

$$\vert \begin{matrix}{\sum }_{i ∈ {𝒩}_{G}} {SF}_{l , i}^{G} {p}_{i , e , b}^{G} ( t ) + {\sum }_{j ∈ {𝒩}_{R}} {SF}_{l , j}^{R} {p}_{j , e , b}^{R} ( t ) + {\sum }_{k ∈ {𝒩}_{ESS}} {SF}_{l , k}^{ESS} [ {p}_{k , e , b}^{DC} ( t ) - \\ {p}_{k , e , b}^{CH} ( t ) ] - {\sum }_{d ∈ {N}_{D}} {SF}_{l , d}^{D} {B}_{d , t , e , b}^{D} {P}_{d , t}^{D} + {p}_{l , e , b}^{SL +} ( t ) - {p}_{l , e , b}^{SL -} ( t )\end{matrix} \vert \leq {\overline{P}}_{l}^{L} , ∀ l , e , b , t \qquad ( 42 )$$

$${p}_{e , b}^{S +} ( t ) , {p}_{e , b}^{S -} ( t ) , {p}_{l , e , b}^{SL +} ( t ) , {p}_{l , e , b}^{SL -} ( t ) \geq 0 , ∀ l , e , b , t \qquad ( 43 )$$

In the unit commitment model considering N−1 fault, the power system needs to deploy unit commitment and unit output decision reasonably to ensure frequency security after N−1 fault. The combination of system frequency modulation aggregated parameters shown in equations (44)-(48) may be linearly represented by decision variables, where H_{e,b}^{G,SYS}(t), D_{t,e,b}^{G,SYS}, R_{e,b}^{G,SYS}(t), F_{e,b}^{H,SYS}(t), T_{e,b}^{R,SYS}(t) represent, respectively, the aggregated inertia time constant, aggregated damping coefficient, droop coefficient, reheat proportional coefficient, and delay coefficient when the system operates normally (b=1) or an N−1 fault (b=2) with index e occurs in renewable energy scenario e and time period t.

$${H}_{e , b}^{G , SYS} ( t ) = \frac{1}{{P}_{BASE}} ( {\sum }_{i ∈ {𝒩}_{G}} {u}_{i}^{G} ( t ) {B}_{i , t , e , b}^{G} {H}_{i}^{G} {\overline{P}}_{i}^{G} + {\sum }_{j ∈ {𝒩}_{R}} {u}_{j}^{R} ( t ) {B}_{j , t , e , b}^{R} {H}_{j}^{R} {\overline{P}}_{j}^{RStation} ) , ∀ e , b , t \qquad ( 44 )$$

$${D}_{t , e , b}^{G , SYS} = \frac{1}{{P}_{BASE}} {\sum }_{d = 1}^{{N}_{D}} {B}_{d , t , e , b}^{D} {D}_{d}^{L} {P}_{d , t}^{D} , ∀ e , b , t \qquad ( 45 )$$

$${[ {R}_{e , b}^{G , SYS} ( t ) ]}^{- 1} = \frac{1}{{P}_{BASE}} {\sum }_{i ∈ {𝒩}_{G}} {u}_{i}^{G} ( t ) {{B}_{i , t , e , b}^{G} ( {R}_{i}^{G} )}^{- 1} {\overline{P}}_{i}^{G} , ∀ e , b , t \qquad ( 46 )$$

$${F}_{e , b}^{H , SYS} ( t ) {[ {R}_{e , b}^{G , SYS} ( t ) ]}^{- 1} = \frac{1}{{P}_{BASE}} {\sum }_{i ∈ {𝒩}_{G}} {u}_{i}^{G} ( t ) {B}_{i , t , e , b}^{G} {{F}_{i}^{H} ( {R}_{i}^{G} )}^{- 1} {\overline{P}}_{i}^{G} , ∀ e , b , t \qquad ( 47 )$$

$${T}_{e , b}^{R , SYS} ( t ) {[ {R}_{e , b}^{G , SYS} ( t ) ]}^{- 1} = \frac{1}{{P}_{BASE}} {\sum }_{i ∈ {𝒩}_{G}} {u}_{i}^{G} ( t ) {B}_{i , t , e , b}^{G} {{T}_{i}^{R} ( {R}_{i}^{G} )}^{- 1} {\overline{P}}_{i}^{G} , ∀ e , b , t \qquad ( 48 )$$

Under the definition of the above aggregated parameters, the maximum frequency change rate constraint shown in equation (15), the maximum frequency deviation constraint shown in equation (23), and the quasi-steady state frequency deviation constraint shown in equation (24) may be equivalently expressed in the form shown in equations (49)-(51), where p_{e,b}^{Delta}(t) represents an active power imbalance value considered by the power system when the system operates normally (b=1) or when an N−1 fault (b=2) with index e occurs in renewable energy scenario e and time period t. It should be noted that when b=1, no actual active power imbalance occurs in the power system, and considering the frequency security of the system is a preventive scheduling measure under normal circumstances.

In equations (49)-(51), variables s_{e,b}^{SHG+}(t), s_{e,b}^{SLH+}(t) and s_{e,b}^{SQS+}(t) are slack variables of the corresponding constraints, respectively. These variables represent the emergency resource values that the power system needs to call to ensure the frequency security of the power grid. These variables have a non-negative limitation, as shown in equation (52).

$${H}_{e , b}^{G , SYS} ( t ) + {s}_{e , b}^{SHG +} ( t ) \geq \vert \frac{{p}_{e , b}^{Delta} ( t )}{2 \cdot {RoCoF}_{threshold}} \vert , ∀ e , b , t \qquad ( 49 )$$

$${L}_{h} ( \begin{matrix}{H}_{e , b}^{G , SYS} ( t ) , {[ {R}_{e , b}^{G , SYS} ( t ) ]}^{- 1} , \\ {{F}_{e , b}^{H , SYS} ( t ) [ {R}_{e , b}^{G , SYS} ( t ) ]}^{- 1} , \\ {{T}_{e , b}^{R , SYS} ( t ) [ {R}_{e , b}^{G , SYS} ( t ) ]}^{- 1}\end{matrix} ) - {δ}_{REG} + {s}_{e , b}^{SLH +} ( t ) \geq \vert \frac{{p}_{e , b}^{Delta} ( t )}{Δ {F}_{threshold}} \vert , \\ ∀ h , t , e , b \qquad ( 50 )$$

$${D}_{t , e , b}^{G , SYS} + {[ {R}_{e , b}^{G , SYS} ( t ) ]}^{- 1} + {s}_{e , b}^{SQS +} ( t ) \geq \vert \frac{{p}_{e , b}^{Delta} ( t )}{{FQSS}_{threshold}} \vert , ∀ t , e , b \qquad ( 51 )$$

$${s}_{e , b}^{SHG +} ( t ) , {s}_{e , b}^{SLH +} ( t ) , {s}_{e , b}^{SQS +} ( t ) \geq 0 , ∀ e , b , t \qquad ( 52 )$$

The constraints that the variable p_{e,b}^{Delta}(t) in equations (49)-(51) needs to satisfy will be explained below.

When the system operates normally (b=1), a potential maximum power disturbance needs to be considered and p_{e,b}^{Delta}(t) needs to satisfy constraint (53); when an N−1 fault (b=2) occurs in the system, p_{e,b}^{Delta}(t) is necessary to consider all fault scenarios e in the set ω_{Λ,n}^{NCut1} (∀Λ) and p_{e,b}^{Delta}(t) needs to satisfy constraint (54).

$${p}_{e , 1}^{Delta} ( t ) \geq max [ {p}_{i , e , 1}^{G} ( t ) , {p}_{j , e , 1}^{R} ( t ) , {p}_{k , e , 1}^{CH} ( t ) , {p}_{k , e , 1}^{DC} ( t ) , {P}_{d , t}^{D} ] , \\ ∀ i , j , k , d , t , e \qquad ( 53 )$$

$${p}_{e , 2}^{Delta} ( t ) = {\sum }_{d = 1}^{{N}_{D}} ( {B}_{d , t - 1 , e , 2}^{D} - {B}_{d , t , e , 2}^{D} ) {P}_{d , t}^{D} + {\sum }_{i ∈ {N}_{G}} ( {B}_{i , t - 1 , e , 2}^{G} - {B}_{i , t , e , 2}^{G} ) {p}_{i , e , 1}^{G} ( t ) + {\sum }_{j ∈ {N}_{R}} ( {B}_{j , t - 1 , e , 2}^{R} - {B}_{j , t , e , 2}^{R} ) {p}_{j , e , 1}^{R} ( t ) + {\sum }_{k ∈ {N}_{R}} ( {B}_{k , t - 1 , e , 2}^{ESS} - {B}_{k , t , e , 2}^{ESS} ) [ {p}_{k , e , 1}^{CH} ( t ) + {p}_{k , e , 1}^{DC} ( t ) ] , ∀ i , j , k , d , t , e \qquad ( 54 )$$

It is noted that the coefficient matrix B_{q,t,e,2}^{Λ} in equation (54) is obtained by training the re-scheduling stage optimization model, but the fault size p_{e,b}^{Delta}(t) may vary with the pre-scheduling variables P_{d,t}^{D}, p_{i,e,1}^{G}(t),p_{j,e,1}^{R}(t),p_{k,e,1}^{CH}(t),p_{k,e,1}^{DC}(t), which is consistent with the physical reality of N−1 fault size. Constraint (54) characterizes the decision dependency characteristics of N−1 fault size influenced by pre-scheduling variable x.

Constraint (55) is a constraint on obtaining the severest intraday renewable energy output and operating cost for N−1 fault scenario, where η is an auxiliary variable that characterizes the highest operating cost during the day.

$$η \geq {\sum }_{t ∈ 𝒯} {\sum }_{i ∈ {𝒩}_{G}} {C}_{i}^{G} {p}_{i , e , 2}^{G} ( t ) + {\sum }_{t ∈ 𝒯} {\sum }_{k ∈ {𝒩}_{ESS}} {C}_{k}^{ESS} [ {p}_{k , e , 2}^{CH} ( t ) + {p}_{k , e , 2}^{DC} ( t ) ] + {\sum }_{t ∈ 𝒯} {C}^{S} [ {p}_{e , 2}^{S +} ( t ) + {p}_{e , 2}^{S -} ( t ) ] + {\sum }_{t ∈ 𝒯} {\sum }_{l ∈ {𝒩}_{L}} {C}^{SL} [ {p}_{l , e , 2}^{SL +} ( t ) + {p}_{l , e , 2}^{SL -} ( t ) ] + {\sum }_{t ∈ 𝒯} {C}^{SF} [ {s}_{e , 2}^{SHG +} ( t ) + {s}_{e , 2}^{SLH +} ( t ) + {s}_{e , 2}^{SQS +} ( t ) ] , ∀ e \qquad ( 55 )$$

Thus, the modeling of power system operation constraints during the pre-scheduling stage is completed.

In the pre-scheduling stage, the objective function of the power system is the minimum scheduling cost, and the objective function is shown in equation (56). For the convenience of expression, equation (56) still partially uses vector x to refer to the pre-scheduling variables mentioned above.

$${min}_{x} {\sum }_{t = 1}^{{N}_{T}} {\sum }_{i = 1}^{{N}_{G}} [ {C}_{i}^{SU} {u}_{i}^{SU} ( t ) + {C}_{i}^{SD} {u}_{i}^{SD} ( t ) ] + η \qquad ( 56 )$$

In the pre-scheduling stage, the overall optimization model of the power system is shown in equation (57):

$${min}_{x} {\sum }_{t = 1}^{{N}_{T}} {\sum }_{i = 1}^{{N}_{G}} [ {C}_{i}^{SU} {u}_{i}^{SU} ( t ) + {C}_{i}^{SD} {u}_{i}^{SD} ( t ) ] + η \qquad ( 57 )$$

$$s . t . constraints ( 27 ) - ( 55 ) .$$

Thus, modeling for the pre-scheduling stage optimization model is completed. The power system makes decisions on the thermal power unit commitment variable u^{R}(t) and the renewable energy station frequency modulation decision variable u^{R}(t) The unit commitment values of these variables are denoted as U_{i,t}^{G}(∀i) and U_{j,t}^{R}(∀j), respectively. Pre-scheduling decisions have significant value for the frequency security of the intraday power system.

In an embodiment, before verifying the unit commitment value of the thermal power unit and the unit commitment value of the renewable energy unit based on the re-scheduling stage optimization model, the method further includes: based on the convex frequency indicator constraint of the power system, the iteration parameters, the renewable energy severe scenario set, and the N−1 fault set, obtaining a decision value of an active power output of the renewable energy units and a decision value of an operating state of an N−1 fault power equipment based on the re-scheduling stage optimization model; determining a decision value of an objective function of the re-scheduling stage optimization model based on the decision value of the active power output of the renewable energy units and the decision value of the operating state of the N−1 fault power equipment; and based on the decision value of the objective function of the re-scheduling stage optimization model, updating an upper bound of the re-scheduling stage optimization model based on a second preset formula, where the second preset formula is:

$${UB}^{CCG} = {SOT}_{n}^{MP} - {H}_{n}^{MP} + {H}_{n}^{SP} ,$$

where UB^{CCG} is the upper bound of the re-scheduling stage optimization model, SOTₙ^{MP} is the decision value of the objective function of the pre-scheduling stage optimization model, Hₙ^{MP} is the decision value of the pre-scheduling variable, Hₙ^{MP} is the decision value of the objective function of the re-scheduling stage optimization model, CCG is the column-and-constraint generation algorithm, n is the iteration parameters, MP is the pre-scheduling stage, and SP is the re-scheduling stage.

In an embodiment, during the re-scheduling stage, the power system has already obtained the unit commitment values U_{i,t}^{G}(∀i) and U_{j,t}^{R}(∀j) of the pre-scheduling stage. The re-scheduling stage is to minimize the operating cost of the power system in the severest renewable energy output and N−1 fault scenario. Therefore, in the rescheduling stage optimization model, the renewable energy output and N−1 fault scenario that may achieve the highest operating cost of the system need to be found.

In the re-scheduling stage optimization model, the active power output of the renewable energy station j during the time period t is denoted as a variable pⱼ^{RN}(t). The variable pⱼ^{RN}(t) (∀j, ∀t) needs to satisfy the following constraints, i.e., the decision value of the active power output of the renewable energy unit.

$${p}_{j}^{RN} ( t ) = {P}_{j , t}^{R} + ( {\overline{P}}_{j , t}^{R} - {P}_{j , t}^{R} ) {u}_{j}^{RDiv +} ( t ) - ( {P}_{j , t}^{R} - {\underline{P}}_{j , t}^{R} ) {u}_{j}^{RDiv -} ( t ) , ∀ j , t \qquad ( 58 )$$

$${u}_{j}^{RDiv +} ( t ) + {u}_{j}^{RDiv -} ( t ) \leq 1 , ∀ j , t \qquad ( 59 )$$

$${\sum }_{j ∈ {𝒩}_{R}} [ {u}_{j}^{RDiv +} ( t ) + {u}_{j}^{RDiv -} ( t ) ] \leq {Γ}_{S}^{R} , ∀ t \qquad ( 60 )$$

$${\sum }_{t ∈ {𝒩}_{T}} [ {u}_{j}^{RDiv +} ( t ) + {u}_{j}^{RDiv -} ( t ) ] \leq {Γ}_{T}^{R} , ∀ j \qquad ( 61 )$$

In constraints (58)-(61), both the variables uⱼ^{RDiv+}(t) and uⱼ^{RDiv-}(t) are variables having a value of 0 or 1, and the value 1 of the variable uⱼ^{RDiv+}(t) or uⱼ^{RDiv-}(t) respectively indicates that the renewable energy station j has reached the upper bound or lower bound of renewable energy output during the time period t and the value 0 indicates that the renewable energy station output has not reached the bound. Due to the extremely low probability that the renewable energy station reaches the output bound at all time periods, Γ_{S}^{R} is set as a spatial clustering coefficient of the renewable energy station, and Γ_{T}^{R} is set as a time smoothing coefficient of the renewable energy station, and the two coefficients may limit the uncertainty range of renewable energy output and reduce the conservatism of scheduling strategies.

In the re-scheduling stage optimization model, it is also defined that the index b represents the operation state of the power system, b=1 indicates normal operation of the power system, b=2 indicates N−1 fault occurs in the power system. Further, it is also defined that a variable a_{q,b}^{Λ}(∀Λ, ∀q, ∀t) having a value of 0 or 1 represents the operation state of power equipment. If the variable a_{q,b}^{Λ}(t) is 1, it indicates that the power equipment q operates normally during a certain time period t when the power system operation state is b, and if the variable a_{q,b}^{Λ}(t) is 1, it indicates that the power equipment q is fault, where the index q may be the index i of the thermal power unit, the index j of the renewable energy unit, the index k of the energy storage power station, or the index of d the load, and corresponding to the type Λ. When the power system operates normally, i.e., b=1, constraints are as shown in equation (62) regarding a_{q,b}^{Λ}(t); and when an N−1 fault occurs in the power system, i.e., b=2, constraint are shown in equations (63)-(64), i.e., the decision value of the operation state of the N−1 fault power equipment.

$${a}_{q , 1}^{Λ} ( t ) = 1 , ∀ Λ , ∀ q , ∀ t \qquad ( 62 )$$

$${a}_{q , 2}^{Λ} ( t ) - {a}_{q , 2}^{Λ} ( t + 1 ) \geq 0 , ∀ Λ , ∀ q , ∀ t \qquad ( 63 )$$

$${\sum }_{∀ Λ} {\sum }_{q ∈ {𝒩}_{Λ}} {\sum }_{t ∈ {𝒩}_{T}} [ {a}_{q , 2}^{Λ} ( t ) - {a}_{q , 2}^{Λ} ( t + 1 ) ] = 1 \qquad ( 64 )$$

Under the above definition, the severest intraday uncertainty scenario may be determined from variables pⱼ^{RN}(t) (∀j, ∀t) and a_{q,b}^{Λ}(t) (∀Λ, ∀q, ∀t). The re-scheduling constraint of the power system considering severe renewable energy scenario and N−1 fault scenario will be explained below.

The thermal power unit needs to satisfy the upper and lower limits of unit output as well as ramp constraints, as shown in equations (65)-(67)., where variable p_{i,b}^{G,C}(t) represents the re-scheduling active power output of the thermal power unit i in the time period t and system state b.

$${U}_{i , t}^{G} {a}_{i , b}^{G} ( t ) {\underline{P}}_{i}^{G} \to \leq {p}_{i , b}^{G , C} ( t ) \leq {U}_{i , t}^{G} {a}_{i , b}^{G} ( t ) {\overline{P}}_{i}^{G} , ∀ i , t , b \qquad ( 65 )$$

$${p}_{i , b}^{G , C} ( t + 1 ) - {p}_{i , b}^{G , C} ( t ) \leq {U}_{i , t}^{G} {R}_{i}^{+} + [ 1 - {U}_{i , t}^{G} ] {\overline{P}}_{i}^{G} , ∀ i , t , b \qquad ( 66 )$$

$${p}_{i , b}^{G , C} ( t ) - {p}_{i , b}^{G , C} ( t + 1 ) \leq {U}_{i , t + 1}^{G} {R}_{i}^{-} + [ 2 - {U}_{i , t + 1}^{G} - {a}_{i , b}^{G} ( t + 1 ) ] {\overline{P}}_{i}^{G} , ∀ i , t , b \qquad ( 67 )$$

The active power output of the renewable energy station needs to satisfy the constraint (68). The variable p_{j,b}^{R,C}(t) represents the active power output of the renewable energy station j in the time period t and system states b.

$$0 \leq {p}_{j , b}^{R , C} ( t ) \leq {a}_{j , b}^{R} ( t ) [ {p}_{j}^{R N} ( t ) - {U}_{j , t}^{R} {P}_{j}^{R S h e d} ] , ∀ j , t , b \qquad ( 68 )$$

It is noted that in equation (68), a product variable of integer variables a_{j,b}^{R}(t) and pⱼ^{RN}(t) are present. Considering that pⱼ^{RN}(t) is defined by equation (68), auxiliary variables z_{j,b}^{RDiv+}(t) and z_{j,b}^{RDiv-}(t) may be defined to replace the product a_{j,b}^{R}(t)uⱼ^{RDIV+}(t) and a_{j,b}^{R}(t)uⱼ^{RDiv-}(t), separately, so z_{j,b}^{RDiv+}(t) and z_{j,b}^{RDiv-}(t) need to satisfy the constraints shown in equations (69)-(72).

$$0 \leq {z}_{j , b}^{R D i v +} ( t ) \leq {a}_{j , b}^{R} ( t ) \qquad ( 69 )$$

$$0 \leq {u}_{j}^{R D i v +} ( t ) - {z}_{j , b}^{R D i v +} ( t ) \leq 1 - {a}_{j , b}^{R} ( t ) \qquad ( 70 )$$

$$0 \leq {z}_{j , b}^{R D i v -} ( t ) \leq {a}_{j , b}^{R} ( t ) \qquad ( 71 )$$

$$0 \leq {u}_{j}^{R D i v -} ( t ) - {z}_{j , b}^{R D i v -} ( t ) \leq 1 - {a}_{j , b}^{R} ( t ) \qquad ( 72 )$$

After auxiliary variables z_{j,b}^{RDiv+}(t) and z_{j,b}^{RDiv-}(t) are defined, constraint (68) may be converted into a constraint form without integer variable products as shown in equation (73):

$$0 \leq {p}_{j , b}^{R , C} ( t ) \leq {a}_{j , b}^{R} ( t ) {P}_{j , t}^{R} + ( {\overline{P}}_{j , t}^{R} - {P}_{j , t}^{R} ) {z}_{j , b}^{R D i v +} ( t ) - ( {P}_{j , t}^{R} - {\underline{P}}_{j , t}^{R} ) {z}_{j , b}^{R D i v -} ( t ) - {a}_{j , b}^{R} ( t ) {U}_{j , t}^{R} {P}_{j}^{R S h e d} , ∀ j , t , b . \qquad ( 73 )$$

Constraints (74)-(79) are energy storage operation constraints. Variables p_{k,b}^{CH,C}(t), p_{k,b}^{DC,C}(t), E_{k,b}^{ESS,C}(t) represent the charging power, discharging power, and stored energy of the energy storage station k, during the time period t and system state b respectively. u_{k,b}^{ESS,C}(t) is a variable having a value of 0 or 1, indicating that energy storage k cannot charge and discharge simultaneously.

$$0 \leq {p}_{k , b}^{CH , C} ( t ) \leq {a}_{k , b}^{E S S} ( t ) [ 1 - {u}_{k , b}^{E S S , C} ( t ) ] {\overline{P}}_{k}^{E S S} , ∀ k , t , b \qquad ( 74 )$$

$$0 \leq {p}_{k , b}^{DC , C} ( t ) \leq {a}_{k , b}^{E S S} ( t ) {u}_{k , b}^{E S S , C} ( t ) {\overline{P}}_{k}^{E S S} , ∀ k , t , b \qquad ( 75 )$$

$${E}_{k , b}^{E S S , C} ( t ) = {E}_{k , b}^{E S S , C} ( t - 1 ) + {η}_{k}^{C H} {p}_{k , b}^{CH , C} ( t ) - \frac{{p}_{k , b}^{DC , C} ( t )}{{η}_{k}^{D C}} , ∀ k , t , b \qquad ( 76 )$$

$${\underline{E}}_{k}^{E S S} \leq {E}_{k , b}^{E S S , C} ( t ) \leq {\overline{E}}_{k}^{E S S} , ∀ k , t , b \qquad ( 77 )$$

$${E}_{k , b}^{E S S , C} ( 0 ) = {E}_{k}^{INT} , ∀ k , b \qquad ( 78 )$$

$${a}_{k , b}^{E S S} ( {N}_{T} ) {E}_{k}^{INT} + [ 1 - {a}_{k , b}^{E S S} ( {N}_{T} ) ] {\underline{E}}_{k}^{E S S} \leq {E}_{k , b}^{E S S , C} ( {N}_{T} ) \leq {a}_{k , b}^{E S S} ( {N}_{T} ) {E}_{k}^{INT} + [ 1 - {a}_{k , b}^{E S S} ( {N}_{T} ) ] {\overline{E}}_{k}^{E S S} , ∀ k , b \qquad ( 79 )$$

Constraints (80)-(82) are system power balance constraint, transmission line capacity constraint, and slack variable non-negative constraint, respectively. Variables p_{b}^{S,C+}(t), p_{b}^{S,C-}(t) represent the emergency power regulation value in the event of power imbalance during the time period t and system state b, respectively; and variables p_{l,b}^{SL,C+}(t), p_{l,b}^{SL,C-}(t) represent the emergency power regulation value required to eliminate the capacity congestion of the transmission line l during the time period t and system state b, respectively.

$${\sum }_{i ∈ {𝒩}_{G}} {p}_{i , b}^{G , C} ( t ) + {\sum }_{j ∈ {𝒩}_{R}} {p}_{j , b}^{R , C} ( t ) + {\sum }_{k ∈ {𝒩}_{E}} {p}_{k , b}^{CH , C} ( t ) - {\sum }_{k ∈ {𝒩}_{ESS}} {p}_{k , b}^{DC , C} ( t ) + {p}_{b}^{S , C +} ( t ) - {p}_{b}^{S , C -} ( t ) = {\sum }_{d ∈ {N}_{D}} {a}_{d , b}^{D} ( t ) {P}_{d , t}^{D} , ∀ t , b \qquad ( 80 )$$

$$\vert \begin{matrix}{\sum }_{i ∈ {𝒩}_{G}} {SF}_{l , i}^{G} {p}_{i , b}^{G , C} ( t ) + {\sum }_{j ∈ {𝒩}_{R}} {SF}_{l , j}^{R} {p}_{j , b}^{R , C} ( t ) + \\ {\sum }_{k ∈ {𝒩}_{ESS}} {SF}_{l , k}^{ESS} [ {p}_{k , b}^{DC , C} ( t ) - {p}_{k , b}^{CH , C} ( t ) ] - \\ {\sum }_{d ∈ {N}_{D}} {SF}_{l , d}^{D} {a}_{d , b}^{D} ( t ) {p}_{d , t}^{D} + \\ {p}_{l , b}^{SL , C +} ( t ) - {p}_{l , b}^{SL , C -} ( t )\end{matrix} \vert \leq {P}_{l}^{- L} , ∀ l , t , b \qquad ( 81 )$$

$${p}_{b}^{S , C +} ( t ) , {p}_{b}^{S , C -} ( t ) , {p}_{l , b}^{S L , C +} ( t ) , {p}_{l , b}^{S L , C -} ( t ) \geq 0 , ∀ l , t , b \qquad ( 82 )$$

In the re-scheduling stage, the aggregated inertia time constant, aggregated damping coefficient, the droop coefficient, the reheat proportional coefficient, and delay coefficient in the time period t and power system state b are denoted as H_{b}^{G,S,C}(t) R_{t,b}^{G,S,C}, R_{b}^{G,S,C}(t), F_{b}^{H,S,C}(t) and T_{b}^{R,S,C}(t), respectively. Therefore, the monomial expression on the left side of equations (83)-(87) may be linearly expressed by a polynomial consisting of the pre-scheduling decision value, equipment parameters, and variable a_{i,b}^{G}(t).

$${H}_{b}^{G , S , C} ( t ) = \frac{1}{{P}_{BASE}} ( {\sum }_{i ∈ {𝒩}_{G}} {U}_{i , t}^{G} {a}_{i , b}^{G} ( t ) {H}_{i}^{G} {\overline{P}}_{i}^{G} + {\sum }_{j ∈ {𝒩}_{R}} {U}_{j , t}^{R} {a}_{j , b}^{R} ( t ) {H}_{j}^{R} {\overline{P}}_{j}^{RStation} ) , ∀ b , t \qquad ( 83 )$$

$${D}_{t , b}^{G , S , C} = \frac{1}{{P}_{BASE}} {\sum }_{d = 1}^{{N}_{D}} {a}_{d , b}^{D} ( t ) {D}_{d}^{L} {P}_{d , t}^{D} , ∀ b , t \qquad ( 84 )$$

$${[ {R}_{b}^{G , S , C} ( t ) ]}^{- 1} = \frac{1}{{P}_{BASE}} {\sum }_{i ∈ {𝒩}_{G}} {U}_{i , t}^{G} {a}_{i , b}^{G} ( t ) {( {R}_{i}^{G} )}^{- 1} {\overline{P}}_{i}^{G} , ∀ b , t \qquad ( 85 )$$

$${{F}_{b}^{H , S , C} ( t ) [ {R}_{b}^{G , S , C} ( t ) ]}^{- 1} = \frac{1}{{P}_{BASE}} {\sum }_{i ∈ {𝒩}_{G}} {U}_{i , t}^{G} {a}_{i , b}^{G} ( t ) {{F}_{i}^{H} ( {R}_{i}^{G} )}^{- 1} {\overline{P}}_{i}^{G} , ∀ b , t \qquad ( 86 )$$

$${{T}_{b}^{R , S , C} ( t ) [ {R}_{b}^{G , S , C} ( t ) ]}^{- 1} = \frac{1}{{P}_{BASE}} {\sum }_{i ∈ {𝒩}_{G}} {U}_{i , t}^{G} {a}_{i , b}^{G} ( t ) {{T}_{i}^{R} ( {R}_{i}^{G} )}^{- 1} {\overline{P}}_{i}^{G} , ∀ b , t \qquad ( 87 )$$

Thus, the maximum frequency change rate constraint, maximum frequency deviation constraint, and quasi-steady state frequency deviation constraint in the re-scheduling stage are shown in equations (88)-(91), where P_{b}^{Delta,C}(t) represents the active power imbalance value considered by the power system in the power system state b and time period t. It is noted that when b=1, no actual active power imbalance has occurred in the power system, it is a preventive scheduling measure to consider the frequency security of the system when b=1.

In equations (88)-(90), variables s_{b}^{SLH,C+}(t) SSLH, s_{b}^{SLH,C+}(t) and s_{b}^{SQS,C+}(t) are slack variables of the corresponding constraints, respectively. These variables represent the emergency resource values that the power system needs to call to ensure the frequency security of the power grid. These variables have non-negative constraints, as shown in equation (91).

$${H}_{b}^{G , S , C} ( t ) + {s}_{b}^{S H G , C +} ( t ) \geq \vert \frac{{p}_{b}^{Delta , C} ( t )}{2 \cdot {RoCoF}_{threshold}} \vert , ∀ b , t \qquad ( 88 )$$

$${L}_{h} ( \begin{matrix}{H}_{b}^{G , S , C} ( t ) , {[ {R}_{b}^{G , S , C} ( t ) ]}^{- 1} , \\ {{F}_{b}^{H , S , C} ( t ) [ {R}_{b}^{G , S , C} ( t ) ]}^{- 1} , \\ {{T}_{b}^{R , S , C} ( t ) [ {R}_{b}^{G , S , C} ( t ) ]}^{- 1}\end{matrix} ) - {δ}_{REG} + {s}_{b}^{SLH , C +} ( t ) \geq \vert \frac{{p}_{b}^{Delta , C} ( t )}{Δ {F}_{threshord}} \vert , ∀ h , t , b \qquad ( 89 )$$

$${D}_{t , b}^{G , S , C} + {[ {R}_{b}^{G , S , C} ( t ) ]}^{- 1} + {s}_{b}^{S Q S , C +} ( t ) \geq \vert \frac{{p}_{b}^{Delta , C} ( t )}{F Q S {S}_{threshold}} \vert , ∀ t , b \qquad ( 90 )$$

$${s}_{b}^{S H G , C +} ( t ) , {s}_{b}^{S L H , C +} ( t ) , {s}_{b}^{S Q S , C +} ( t ) \geq 0 , ∀ b , t . \qquad ( 91 )$$

When b=1, the power system needs to consider the maximum potential power disturbance, constraint (92) is related to p_{b}^{Delta,C}(t); when b=2, p_{b}^{Delta}(t) requires to consider N−1 fault caused by a_{q,b}^{Λ}(t) and constraint (93) is required to be considered.

$${p}_{1}^{Delta , C} ( t ) \geq max [ {p}_{i , 1}^{G , C} ( t ) , {p}_{j , 1}^{R , C} ( t ) , {p}_{k , 1}^{CH , C} ( t ) , {p}_{k , 1}^{DC , C} ( t ) , {P}_{d , t}^{D} ] , ∀ i , j , k , d , t \qquad ( 92 )$$

$${p}_{2}^{Delta , C} ( t ) = {\sum }_{d = 1}^{{N}_{D}} [ {a}_{d , 2}^{D} ( t - 1 ) - {a}_{d , 2}^{D} ( t ) ] {P}_{d , t}^{D} + {\sum }_{i ∈ {N}_{G}} [ {a}_{i , 2}^{G} ( t - 1 ) - {a}_{i , 2}^{G} ( t ) ] {p}_{i , 1}^{G , C} ( t ) + {\sum }_{j ∈ {N}_{R}} [ {a}_{j , 2}^{R} ( t - 1 ) - {a}_{j , 2}^{R} ( t ) ] {p}_{j , 1}^{R , C} ( t ) + {\sum }_{k ∈ {N}_{R}} [ {a}_{k , 2}^{E S S} ( t - 1 ) - {a}_{k , 2}^{E S S} ( t ) ] {p}_{k , 1}^{CH , C} ( t ) ++ {\sum }_{k ∈ {N}_{R}} [ {a}_{k , 2}^{E S S} ( t - 1 ) - {a}_{k , 2}^{E S S} ( t ) ] {p}_{k , 1}^{D C C} ( t ) , ∀ i , j , k , d , t \qquad ( 93 )$$

Thus, the modeling of operation constraints during the re-scheduling stage is completed.

In the re-scheduling stage, the objective function of the power system is to minimize the operating cost of the power system in the severest scenario. Therefore, the objective function in the re-scheduling stage has a “max min” coupling form, as shown in equation (94). For the convenience of expression, equation (94) still partially uses vectors to refer to the re-scheduling variables mentioned above.

$${\sum }_{t ∈ 𝒯} {\sum }_{i ∈ {𝒩}_{G}} {C}_{i}^{G} {p}_{i , 2}^{G , C} ( t ) + {\sum }_{t ∈ 𝒯} {\sum }_{k ∈ {𝒩}_{ESS}} {C}_{k}^{E S S} [ {p}_{k , 2}^{CH , C} ( t ) + {p}_{k , 2}^{DC , C} ( t ) ] + {{max}_{{p}_{j}^{RN} ( t ) , {u}_{j}^{RDiv +} ( t )}}_{{u}_{j}^{RDiv -} ( t ) , {a}_{q , b}^{Λ} ( t )} {min}_{y} {\sum }_{t ∈ 𝒯} {C}^{S} [ {p}_{2}^{S , C +} ( t ) + {p}_{2}^{S , C -} ( t ) ] + {\sum }_{t ∈ 𝒯} {\sum }_{l ∈ {𝒩}_{L}} {C}^{S L} [ {p}_{l , 2}^{SL , C +} ( t ) + {p}_{l , 2}^{SL , C -} ( t ) ] + {\sum }_{t ∈ 𝒯} {C}^{S F} [ {s}_{2}^{SHG , C +} ( t ) + {s}_{2}^{SLH , C +} ( t ) + {s}_{2}^{SQS , C +} ( t ) ] \qquad ( 94 )$$

Thus, in the re-scheduling stage, the optimization model of the power system is shown in equation (95).

$${\sum }_{t ∈ 𝒯} {\sum }_{i ∈ {𝒩}_{G}} {C}_{i}^{G} {p}_{i , 2}^{G , C} ( t ) + {\sum }_{t ∈ 𝒯} {\sum }_{k ∈ {𝒩}_{ESS}} {C}_{k}^{E S S} [ {p}_{k , 2}^{CH , C} ( t ) + {p}_{k , 2}^{DC , C} ( t ) ] + {{max}_{{p}_{j}^{RN} ( t ) , {u}_{j}^{RDiv +} ( t )}}_{{u}_{j}^{RDiv -} ( t ) , {a}_{q , b}^{Λ} ( t )} {min}_{y} {\sum }_{t ∈ 𝒯} {C}^{S} [ {p}_{2}^{S , C +} ( t ) + {p}_{2}^{S , C -} ( t ) ] + {\sum }_{t ∈ 𝒯} {\sum }_{l ∈ {𝒩}_{L}} {C}^{S L} [ {p}_{l , 2}^{SL , C +} ( t ) + {p}_{l , 2}^{SL , C -} ( t ) ] + {\sum }_{t ∈ 𝒯} {C}^{S F} [ {s}_{2}^{SHG , C +} ( t ) + {s}_{2}^{SLH , C +} ( t ) + {s}_{2}^{SQS , C +} ( t ) ] \qquad ( 95 )$$

$$s . t . \begin{matrix}constraints ( 58 ) - ( 67 ) \\ constraints ( 69 ) - ( 93 )\end{matrix}$$

2, Verifying the unit commitment value of the thermal power unit and the unit commitment value of the renewable energy unit based on the re-scheduling stage optimization model.

In an embodiment, verifying the unit commitment value of the thermal power unit and the unit commitment value of the renewable energy unit based on the re-scheduling stage optimization model includes: when the lower bound of the pre-scheduling stage optimization model and the upper bound of the re-scheduling stage optimization model satisfy a third preset formula, indicating that the verification of the unit commitment value of the thermal power unit and the unit commitment value of the renewable energy unit successes; and when the lower bound of the pre-scheduling stage optimization model and the upper bound of the re-scheduling stage optimization model do not satisfy the third preset formula, indicating that the verification of the unit commitment value of the thermal power unit and the unit commitment value of the renewable energy unit fails, where the third preset formula is:

$${UB}^{CCG} - {LB}^{CCG} \leq {δ}_{CCG} ,$$

where LB^{CCG} is the lower bound of the pre-scheduling stage optimization model, UB^{CCG} is the upper bound of the re-scheduling stage optimization model, and δ_{CCG} is a preset convergence threshold.

3, When the verification of the unit commitment value of the thermal power unit and the unit commitment value of the renewable energy unit successes, the unit commitment value of the thermal power unit and the unit commitment value of the renewable energy unit are taken as final unit commitment values.

4, When the verification of the unit commitment value of the thermal power unit and the unit commitment value of the renewable energy unit fails, the pre-scheduling stage optimization model is updated and the determining step and the verifying step are repeated based on the updated pre-scheduling stage optimization model until the verification of the unit commitment value of the thermal power unit and the unit commitment value of the renewable energy unit obtained again successes, and the verified unit commitment value of the thermal power unit and the verified unit commitment value of the renewable energy unit are taken as the final unit commitment values.

In an embodiment, when the verification of the unit commitment value of the thermal power unit and the unit commitment value of the renewable energy unit fails, the updating pre-scheduling stage optimization model includes: when the lower bound of the pre-scheduling stage optimization model and the upper bound of the re-scheduling stage optimization model do not satisfy the third preset formula, updating the iteration parameters, updating the renewable energy severe scenario set, and the N−1 fault set to update the pre-scheduling stage optimization model based on the updated iteration parameters, the renewable energy severe scenario set, and the N−1 fault set.

The process of the algorithm based on column-and-constraint generation (CCG) is as follows.

1) Initializing. An iteration number n is initialized to 1. The lower bound for the optimal value of the pre-scheduling stage optimization model and the upper bound for the re-scheduling stage optimization model are denoted as LB^{CCG} and UB^{CCG} respectively. LB^{CCG}=−M^{big} and UB^{CCG} M^{big} are initialized, the convergence threshold δ_{CCG} is set for the upper and lower bounds, the number of elements Nₙ^{Iter} is initialized to 1 in Ωₙ^{R} and Ω_{Λ,n}^{NCut1} (∀Λ), the element P_{j,t,1}^{RN} in Ωₙ^{R} is set to be the forecast center value P_{j,t}^{R} (∀j, t) of the renewable energy station, and, the element A_{q,t,1}^{Λ} in Ω_{Λ,n}^{NCut1} is 1 (∀Λ, ∀q, ∀t).

2) Updating the lower bound. The pre-scheduling stage optimization model (57) is trained, where the optimal value for the pre-scheduling stage optimization model is denoted as SOTₙ^{MP}, the decision value for the pre-scheduling variable η, the unit commitment value for thermal power unit uᵢ^{G}(t), and the unit commitment value for renewable energy unit uⱼ^{R}(t) are denoted as Hₙ^{MP}, U_{i,t,n}^{G} (∀i), U_{j,t,n}^{R} (∀j), respectively, and the subscript n represents the number of iterations. The lower bound of the pre-scheduling stage optimization model is updated as LB^{CCG}=SOTₙ^{MP}.

3) Updating upper bound. The re-scheduling stage optimization model (95) is trained, where the optimal values of the re-scheduling stage optimization model is denoted as Hₙ^{MP}, and the decision value of the active power output pⱼ^{RN}(t) of the renewable energy unit and the decision value of the operation state a_{q,2}^{Λ}(t) of the N−1 fault power equipment are denoted as P_{j,t,n}^{RN,C} (∀i, t) and A_{q,t,n}^{Λ,C} (∀q, t), respectively. The upper bound of the re-scheduling stage optimization model is updated as UB^{CCG}=SOTₙ^{MP}−Hₙ^{SP}.

4) Determining convergence. If a convergence criterion of the third preset formula is satisfied, then the iteration process ends, the calculation is terminated, and the U_{i,t,n}^{G} (∀i) and U_{j,t,n}^{R} (∀j) in step 2) are output as the unit commitment value for the thermal power unit and the unit commitment value for the renewable energy unit; otherwise, the iteration number n is updated by n+1, p_{j,t,n}^{RN,C} (∀i, t) and A_{q,t,n}^{Λ,C} (∀q, t) in step 3) are added to the renewable energy severe scenario set Ωₙ^{R} and N−1 fault set Ω_{Λ,n}^{NCut1}, respectively. The value of the number Nₙ^{Iter} in scenarios of Ωₙ^{R} and Ω_{Λ,n}^{NCut1} (∀Λ) are updated, and the procedure returns to step 2) to update the lower bound of the re-scheduling stage optimization model.

The above steps may iteratively train the unit commitment model of the present application.

In summary, the present application designs a unit commitment method for the day-ahead unit commitment scheduling model of the power system, considering frequency constraints and N−1 fault decision dependency characteristics. In terms of modeling frequency indicator constraint, the present application uses an outer approximation based method to perform linear conversion; in terms of modeling N−1 fault, the present application characterizes the decision dependency characteristics of N−1 fault; on the basis of frequency indicator constraint based on outer approximation and N−1 fault decision dependency characteristics, the present application constructs an N−1 secure and robust unit commitment method considering frequency constraints. This method may make decisions on the unit commitment in the power system and calculate unit commitment plans that ensure frequency security and power supply-demand balance after N−1 disturbance in the power system.

The beneficial effects of the present application are as follows.

Firstly, in terms of linearization convert of non-convex frequency indicator constraints, the present application utilizes an outer approximation algorithm to approximately convert the frequency indicator constraint for frequency lowest point constraints with non-convex characteristics. This method avoids the introduction of integer variables in the non-convex constraint conversion process, significantly reduces the computational complexity of the model, and may ensure the accuracy of the solution within the typical frequency modulation parameter range of the power system.

Secondly, in the modeling of N−1 active power disturbances in the power system, the present application considers the decision dependency characteristics of the N−1 fault set affected by unit commitment value and unit output value, and constructs constraint equations that characterizes the decision dependency characteristics of N−1 fault size in power systems. The constraint has a higher degree of coincidence with an actual power system and may more accurately reflect the active power disturbance caused by N−1 fault in the actual power system.

Thirdly, by incorporating the maximum frequency deviation constraint based on outer approximation and the constraint equation that characterizes the decision dependency of N−1 fault size in the two-layer robust unit commitment model, the present application has advantages in reducing the complexity of solving the frequency lowest point constraint, ensuring system frequency security after N−1 fault, improving the renewable energy penetration, and reducing system operating costs.

Fourthly, the method proposed in the present application has generality, and for models with decision dependency characteristics in the fields of integrated energy and transportation networks, the present application further provides inspiration and assistance in modeling and training.

FIG. 4 illustrates a schematic diagram of a physical structure of an electronic device. As shown in FIG. 4, the electronic device may include: a processor 401, a communication interface 402, a memory 403, and a communication bus 404, where the processor 401, the communication interface 402 and the memory 403 communicate with each other through the communication bus 404. The processor 401 may call a logical instruction in the memory 403 to execute a unit commitment method for a power system, applied to the power system, and the power system at least includes a thermal power unit and a renewable energy unit. The method includes: determining a unit commitment value of the thermal power unit and a unit commitment value of the renewable energy unit obtained based on a pre-scheduling stage optimization model by considering an N−1 fault and frequency security of the power system; verifying the unit commitment value of the thermal power unit and the unit commitment value of the renewable energy unit based on a re-scheduling stage optimization model; when the verification of the unit commitment value of the thermal power unit and the unit commitment value of the renewable energy unit successes, taking the unit commitment value of the thermal power unit and the unit commitment value of the renewable energy unit as a final unit commitment value; when the verification of the unit commitment value of the thermal power unit and the unit commitment value of the renewable energy unit fails, updating the pre-scheduling stage optimization model, and repeating the determining step and the verifying step based on the updated pre-scheduling stage optimization model until the verification of the unit commitment value of the thermal power unit and the unit commitment value of the renewable energy unit obtained again successes, taking the verified unit commitment value of the thermal power unit and the verified unit commitment value of the renewable energy unit as the final unit commitment value, where the N−1 fault represents a contingency in which a component in the power system exits operation.

In addition, the logical instruction in the memory 403 mentioned above may be implemented in the form of software functional unit and stored in a computer-readable storage medium when sold or used as independent products. Based on such understanding, the solutions of the present application in essence or a part of the solutions that contributes to the related art, or all or part of the solutions, can be embodied in the form of a software product, which is stored in a storage medium, including several instructions to cause a computer device (which can be a personal computer, server, or network device, etc.) or a processor to perform all or part of the steps of the methods described in the respective embodiments of the present application. The storage medium described above includes various media that can store program codes, such as USB flash disk, mobile hard disk, read-only memory (ROM), random access memory (RAM), magnetic disk, or optical disk.

The present application further provides a computer program product including a computer program that may be stored on a non-transient computer-readable storage medium. When the computer program is executed by a processor, the computer may execute a unit commitment method for a power system, applied to the power system, and the power system at least includes a thermal power unit and a renewable energy unit. The method includes: determining a unit commitment value of the thermal power unit and a unit commitment value of the renewable energy unit obtained based on a pre-scheduling stage optimization model by considering an N−1 fault and frequency security of the power system; verifying the unit commitment value of the thermal power unit and the unit commitment value of the renewable energy unit based on a re-scheduling stage optimization model; when the verification of the unit commitment value of the thermal power unit and the unit commitment value of the renewable energy unit successes, taking the unit commitment value of the thermal power unit and the unit commitment value of the renewable energy unit as a final unit commitment value; when the verification of the unit commitment value of the thermal power unit and the unit commitment value of the renewable energy unit fails, updating the pre-scheduling stage optimization model, and repeating the determining step and the verifying step based on the updated pre-scheduling stage optimization model until the verification of the unit commitment value of the thermal power unit and the unit commitment value of the renewable energy unit obtained again successes, taking the verified unit commitment value of the thermal power unit and the verified unit commitment value of the renewable energy unit as the final unit commitment value, where the N−1 fault represents a contingency in which a component in the power system exits operation.

The present application further provides a non-transient computer-readable storage medium on which a computer program is stored. And the computer program implements, when executed by a processor, a unit commitment method for a power system, applied to the power system, and the power system at least includes a thermal power unit and a renewable energy unit. The method includes: determining a unit commitment value of the thermal power unit and a unit commitment value of the renewable energy unit obtained based on a pre-scheduling stage optimization model by considering an N−1 fault and frequency security of the power system; verifying the unit commitment value of the thermal power unit and the unit commitment value of the renewable energy unit based on a re-scheduling stage optimization model; when the verification of the unit commitment value of the thermal power unit and the unit commitment value of the renewable energy unit successes, taking the unit commitment value of the thermal power unit and the unit commitment value of the renewable energy unit as a final unit commitment value; when the verification of the unit commitment value of the thermal power unit and the unit commitment value of the renewable energy unit fails, updating the pre-scheduling stage optimization model to repeat the determining step and the verifying step based on the updated pre-scheduling stage optimization model until the verification of the unit commitment value of the thermal power unit and the unit commitment value of the renewable energy unit obtained again successes, taking the verified unit commitment value of the thermal power unit and the verified unit commitment value of the renewable energy unit as the final unit commitment value, where the N−1 fault represents a contingency in which a component in the power system exits operation.

The device embodiments described above are only illustrative, where the units described as separate components may or may not be physically separated, and the components displayed as units may or may not be physical units, that is, they may be located in one place or distributed across multiple network units. Some or all modules may be selected according to actual needs to achieve the purpose of this embodiment. Those ordinarily skilled in the art may understand and implement it without creative effort.

Through the description of the above implementation methods, those ordinarily skilled in the art may clearly understand that each implementation method may be achieved through software and necessary general hardware platforms, and may also be achieved through hardware. Based on such understanding, the above-mentioned technical solutions or the parts that contribute to the prior art may be reflected in the form of software products, which may be stored in computer-readable storage media such as ROM/RAM, disks, CDs, etc., including several instructions to enable a computer device (which may be a personal computer, a server, or a network device, etc.) to execute the methods described in various embodiments or certain parts of the embodiments.

Finally, it should be noted that the above embodiments are only used to explain the technical solutions of the present application, and are not limited thereto; although the present application has been described in detail with reference to the foregoing embodiments, it should be understood by those skilled in the art that they can still modify the technical solutions documented in the foregoing embodiments and make equivalent substitutions to a part of the technical features; these modifications and substitutions do not make the essence of the corresponding technical solutions depart from the scope of the technical solutions of various embodiments of the present application.

1. A unit commitment method for a power system, wherein the power system comprises at least a thermal power unit and a renewable energy unit, and the method comprises:
determining a unit commitment value of the thermal power unit and a unit commitment value of the renewable energy unit obtained based on a pre-scheduling stage optimization model by considering an N−1 fault and frequency security of the power system;
verifying the unit commitment value of the thermal power unit and the unit commitment value of the renewable energy unit based on a re-scheduling stage optimization model;
when the verification of the unit commitment value of the thermal power unit and the unit commitment value of the renewable energy unit successes, taking the unit commitment value of the thermal power unit and the unit commitment value of the renewable energy unit as a final unit commitment value; and
when the verification of the unit commitment value of the thermal power unit and the unit commitment value of the renewable energy unit fails, updating the pre-scheduling stage optimization model, and repeating the determining step and the verifying step based on the updated pre-scheduling stage optimization model until the verification successes, taking the verified unit commitment value of the thermal power unit and the verified unit commitment value of the renewable energy unit as the final unit commitment value, wherein the N−1 fault represents a contingency in which a component in the power system exits operation.

2. The method of claim 1, wherein the determining the unit commitment value of the thermal power unit and the unit commitment value of the renewable energy unit obtained based on the pre-scheduling stage optimization model by considering the N−1 fault and frequency security of the power system comprises:
determining a convex frequency indicator constraint of the power system from parameters of the power system based on a frequency response transfer function model and an outer approximation algorithm, wherein the convex frequency indicator constraint of the power system comprises a maximum frequency change rate constraint, a maximum frequency deviation constraint, and a quasi-steady state frequency deviation constraint;
initializing iteration parameters, a renewable energy severe scenario set, and an N−1 fault set; and
based on the convex frequency indicator constraint of the power system, the iteration parameters, the renewable energy severe scenario set, and the N−1 fault set, obtaining a decision value of pre-scheduling variables, the unit commitment value of the thermal power unit, and the unit commitment value of the renewable energy unit obtained based on the pre-scheduling stage optimization model by considering the N−1 fault and frequency security of the power system.

3. The method of claim 2, wherein after the determining the unit commitment value of the thermal power unit and the unit commitment value of the renewable energy unit obtained based on the pre-scheduling stage optimization model by considering the N−1 fault and frequency security of the power system, the method further comprises:
obtaining a decision value of an objective function of the pre-scheduling stage optimization model based on the decision value of the pre-scheduling variables, the unit commitment value of the thermal power unit, and the unit commitment value of the renewable energy unit; and
updating a lower bound of the pre-scheduling stage optimization model based on the decision value of the objective function of the pre-scheduling stage optimization model using a first preset formula, wherein the first preset formula is:
LB^{CCG}=SOTₙ^{MP},
wherein LB^{CCG} is the lower bound of the pre-scheduling stage optimization model, CCG is a column-and-constraint generation algorithm, SOTₙ^{MP} is the decision value of the objective function of the pre-scheduling stage optimization model, n is the iteration parameters, and MP is the pre-scheduling stage.

4. The method of claim 3, wherein before verifying the unit commitment value of the thermal power unit and the unit commitment value of the renewable energy unit based on the re-scheduling stage optimization model, the method further comprises:
based on the convex frequency indicator constraint of the power system, the iteration parameters, the renewable energy severe scenario set, and the N−1 fault set, obtaining a decision value of an active power output of the renewable energy unit and a decision value of an operating state of an N−1 fault power equipment based on the re-scheduling stage optimization model;
determining a decision value of an objective function of the re-scheduling stage optimization model based on the decision value of the active power output of the renewable energy units and the decision value of the operating state of the N−1 fault power equipment; and
based on the decision value of the objective function of the re-scheduling stage optimization model, updating an upper bound of the re-scheduling stage optimization model based on a second preset formula, wherein the second preset formula is:
$${UB}^{CCG} = {SOT}_{n}^{MP} - {H}_{n}^{MP} + {H}_{n}^{SP} ,$$
wherein UB^{CCG} is the upper bound of the re-scheduling stage optimization model, SOTₙ^{MP} is the decision value of the objective function of the pre-scheduling stage optimization model, Hₙ^{MP} is the decision value of the pre-scheduling variable, Hₙ^{MP} is the decision value of the objective function of the re-scheduling stage optimization model, CCG is the column-and-constraint generation algorithm, n is the iteration parameters, MP is the pre-scheduling stage, and SP is the re-scheduling stage.

5. The method of claim 4, wherein the verifying the unit commitment value of the thermal power unit and the unit commitment value of the renewable energy unit based on the re-scheduling stage optimization model comprises:
when the lower bound of the pre-scheduling stage optimization model and the upper bound of the re-scheduling stage optimization model satisfy a third preset formula, indicating that verification of the unit commitment value of the thermal power unit and the unit commitment value of the renewable energy unit successes; and
when the lower bound of the pre-scheduling stage optimization model and the upper bound of the re-scheduling stage optimization model do not satisfy the third preset formula, indicating that the verification of the unit commitment value of the thermal power unit and the unit commitment value of the renewable energy unit fails, wherein the third preset formula is:
$${UB}^{CCG} - {LB}^{CCG} \leq {δ}_{CCG} ,$$
wherein LB^{CCG} is the lower bound of the pre-scheduling stage optimization model, UB^{CCG} is the upper bound of the re-scheduling stage optimization model, and δ_{CCG} is a preset convergence threshold.

6. The method of claim 5, wherein when the verification of the unit commitment value of the thermal power unit and the unit commitment value of the renewable energy unit fails, updating the pre-scheduling stage optimization model comprises:
when the lower bound of the pre-scheduling stage optimization model and the upper bound of the re-scheduling stage optimization model do not satisfy the third preset formula, updating the iteration parameters, updating the renewable energy severe scenario set, and the N−1 fault set to update the pre-scheduling stage optimization model based on the updated iteration parameters, the updated renewable energy severe scenario set, and the updated N−1 fault set.

7. The method of claim 2, wherein determining the convex frequency indicator constraint of the power system from the parameters of the power system based on the frequency response transfer function model and the outer approximation algorithm comprises:
obtaining a non-convex nonlinear frequency indicator constraint of the power system from the parameters of the power system based on the frequency response transfer function model of the power system; and
converting the non-convex nonlinear frequency indicator constraint of the power system into the convex frequency indicator constraint applicable to the pre-scheduling stage optimization model and the re-scheduling stage optimization model of the power system based on the outer approximation algorithm.

8. An electronic device, comprising a memory, a processor, and a computer program stored on the memory and capable of running on the processor, wherein the processor, when executing the program, performs the unit commitment method for the power system of claim 1.

9. A non-transient computer-readable storage medium on which a computer program is stored, wherein the computer program, when executed by a processor, performs the unit commitment method for the power system of claim 1.

10. A computer program product comprising a computer program, wherein the computer program, when executed by a processor, performs the unit commitment method for the power system of claim 1.
